(19) United States
(12) Patent Application Publication
(10) Pub. No.: US 2018/0284700 A1
(43) Pub. Date: Oct. 4, 2018

(54) Electronic Timepiece

(71) Applicant: Seiko Epson Corporation, Tokyo (JP)

(72) Inventor: Yasuo Nakajima, Suwa (JP)

(21) Appl. No.: 15/938,297

(22) Filed: Mar. 28, 2018

(30) Foreign Application Priority Data
Mar. 29, 2017 (JP) 2017-066173
Dec. 21, 2017 (JP) 2017-245503

(51) Int. Cl. G04R 60/10; G04R 20/02; H01Q 1/27; H01Q 9/04

(52) U.S. Cl. CPC G04R 60/10; H01Q 9/0407; H01Q 1/273; G04R 20/02

(57) ABSTRACT

An electronic timepiece includes a planar antenna that receives a circularly polarized wave and a controller that activates the planar antenna. The planar antenna includes an antenna electrode having a degeneracy separator and a power feeder. The power feeder is disposed within a first angular range or a second angular range with respect to the center of the planar antenna. The first angular range is an angular range from a 1.5-o'clock direction to a 4.5-o'clock direction and the second angular range is an angular range from a 7.5-o'clock direction to a 10.5-o'clock direction.

### BACKGROUND

### 1. Technical Field

The present invention relates to an electronic timepiece, and particularly to an electronic timepiece including a planar antenna.

### 2. Related Art

A known electronic timepiece includes a planar antenna that receives an electric wave transmitted from a position information satellite such as a GPS (global positioning system) satellite (see JP-A-2015-175738).

The electronic timepiece uses a patch antenna having an electrode shape designed so as to have a reception characteristic that allows reception of a linearly polarized wave (see paragraphs 0037 and 0038 in JP-A-2015-175738). JP-A-2015-175738 describes that a power feeder is disposed at the patch antenna's side close to a metal member to avoid interference due to a metal barrel, a battery, and other metal members so that the reception sensitivity is increased along the patch antenna's sides perpendicular to the side where the power feeder is disposed for improvement in reception sensitivity of the patch antenna as a whole.

However, since a GPS satellite signal is transmitted in the form of a circularly polarized wave, it is preferable that the planar antenna can also directly receive a circularly polarized wave. To this end, a planar antenna capable of receiving a circularly polarized wave is required to improve the reception sensitivity.

Further, an electronic timepiece including a planar antenna is typically configured in consideration of the directivity of the planar antenna so that a user operates a button or otherwise manipulates the timepiece to manually instruct reception of a satellite signal with the front surface of the electronic timepiece (side facing the cover glass plate) facing the zenith. In this case, if the user does not perform the manual reception for a long period, the time display accuracy decreases because no internal time correction based on the satellite signal is performed.

An electronic timepiece including a planar antenna therefore needs to automatically receive a satellite signal without the user's operation of a button or other manipulation of the timepiece.

In the automatic reception, however, since the electronic timepiece does not always face the zenith, there is a new problem of a decrease in the reception sensitivity and hence a decrease in the probability of successful automatic reception.

### SUMMARY

An advantage of some aspects of the invention is to provide an electronic timepiece capable of receiving a circularly polarized wave and improving the probability of successful automatic reception.

An aspect of the invention is directed to an electronic timepiece including a case, a planar antenna that is disposed in the case and receives a circularly polarized wave, and a controller that activates the planar antenna. The planar antenna includes an antenna electrode having a degeneracy separator and further includes a power feeder. The power feeder is disposed within a first angular range or a second angular range with respect to a center of the planar antenna. The first angular range is an angular range from a 1.5-o'clock direction to a 4.5-o'clock direction and the second angular range is an angular range from a 7.5-o'clock direction to a 10.5-o'clock direction provided that a direction from the center of the planar antenna is taken to be analogous to a direction from a center of a dial of the timepiece toward markings on the dial.

According to the aspect of the invention, the planar antenna includes the antenna electrode having a degeneracy separator. The thus configured planar antenna can receive a circularly polarized wave, such as a GPS satellite signal, and can also improve the satellite signal reception sensitivity.

Further, since the power feeder is disposed within the first angular range (90-degree angular range from 1.5-o'clock direction to 4.5-o'clock direction) or in the second angular range (90-degree angular range from 7.5-o'clock direction to 10.5-o'clock direction) with respect to the center of the planar antenna, the directivity of the electronic timepiece in the side surface direction can be set within the 90-degree angular range around the 3-to-9-o'clock direction, which connects a 3-o'clock marking to a 9-o'clock marking on the dial.

The present inventor has studied a planar antenna that receives a circularly polarized wave and newly found that the directivity of the electronic timepiece in the side surface direction changes depending on the position where the power feeder is disposed, and that the planar antenna has high sensitivity in the direction that connects the center of the planar antenna to the position where the power feeder is disposed. The present inventor then used the characteristic described above to design an electronic timepiece capable of improving the probability of successful automatic reception.

That is, when a user wears the electronic timepiece around the user's wrist, the direction from the wrist toward the elbow coincides with the 3-to-9-o'clock direction of the electronic timepiece. When the user walks outdoors, the arms are usually located below the shoulders, so that the 3-to-9-o'clock direction of the electronic timepiece is oriented toward the zenith. In view of the fact described above, the planar antenna, in a case it has directivity within a 90-degree angular range around the 3-to-9-o'clock direction of the electronic timepiece, readily receives a signal from a satellite located in the zenith direction, whereby the satellite signal reception sensitivity can be improved. Therefore, even when the electronic timepiece automatically starts satellite signal reception during the user's outdoor walking, the probability of successful satellite signal reception can be increased. When the probability of successful reception increases, the internal time can be automatically corrected. An electronic timepiece that can improve the accuracy of displayed time and provides a high degree of convenience can therefore be provided.

In the electronic timepiece according to the aspect of the invention, it is preferable that the power feeder is disposed in a 3-o'clock or 9-o'clock position with respect to the center of the planar antenna.

In the configuration in which the power feeder is disposed in the 3-o'clock or 9-o'clock direction, the 3-to-9-o'clock direction of the electronic timepiece can be oriented toward the zenith when the arms extend downward in the vertical direction. Therefore, even when the arms move forward and rearward during walking, a change in the reception sensitivity can be reduced, whereby the probability of successful automatic reception can be further improved.

In the electronic timepiece according to the aspect of the invention, it is preferable that a position of the center of the planar antenna is located within an angular range from an 11-o'clock direction to a 1-o'clock direction or an angular range from a 5-o'clock direction to a 7-o'clock direction with respect to a center of the case in a plan view.

According to the configuration described above, for example, in a case where a planar antenna having a rectangular shape in the plan view is disposed in a case having a circular shape in the plan view and in a 12-o'clock or 6-o'clock position with respect to the center of the case in the plan view, the planar antenna can be so disposed that the 12-o'clock-side or 6-o'clock-side side surface of the planar antenna is close to the case, but the 3-o'clock-side and 9-o'clock-side side surfaces thereof are separate from the case. Therefore, when the power feeder is disposed in the first or second angular range, the power feeder can be separate from the case, whereby the electrically conductive case is unlikely to affect the planar antenna. The reception sensitivity of the planar antenna can therefore be improved as compared with a case where the power feeder is disposed in a position facing the side surface closest to the case.

In the electronic timepiece according to the aspect of the invention, it is preferable that the planar antenna includes a dielectric substrate, the antenna electrode provided on a front surface of the dielectric substrate, a ground electrode provided on a rear surface of the dielectric substrate, and a power feeding electrode provided on the rear surface, and that the power feeder is the power feeding electrode.

According to the configuration described above, the power feeder can be formed of a strip electrode, and the thickness of the planar antenna can therefore be reduced as compared with a case using a power feeder pin, whereby the planar antenna can be readily manufactured in a surface mounting process.

In the electronic timepiece according to the aspect of the invention, it is preferable that the planar antenna includes a dielectric substrate, the antenna electrode provided on a front surface of the dielectric substrate, a ground electrode provided on a rear surface of the dielectric substrate, a power feeding electrode provided on the rear surface, and a side surface electrode provided on a side surface of the dielectric substrate and caused to be electrically continuous with the power feeding electrode, and that the power feeder is formed of the power feeding electrode and the side surface electrode.

According to the configuration described above, the power feeder can be formed of a strip electrode, and the thickness of the planar antenna can therefore be reduced as compared with a case using a power feeder pin, whereby the planar antenna can be readily manufactured in a surface mounting process.

In the electronic timepiece according to the aspect of the invention, it is preferable that the electric timepiece further includes a battery disposed in the case, and that an interior of the case is imaginarily divided into two regions by a straight line that is perpendicular to a straight line passing through a center of the case and the center of the planar antenna and passes through the center of the case, and the battery is disposed in a region different from a region where the planar antenna is disposed.

According to the configuration described above, the planar antenna can be disposed so as to be separate from the battery. The influence of the battery on the planar antenna can therefore be suppressed, whereby the reception sensitivity of the planar antenna can be improved as compared with a case where the battery is disposed in the same region where the planar antenna is disposed.

In the electronic timepiece according to the aspect of the invention, it is preferable that the electric timepiece further includes a metal member that is disposed in a position shifted from the planar antenna toward a front surface of the timepiece in a thickness direction of the case and does not overlap with the planar antenna in a plan view, and that a minimum distance between the metal member and the antenna electrode is at least 80% a thickness of the planar antenna.

In the electronic timepiece, an antimagnetic plate, an electrode section of a solar cell panel, and other metal members are disposed in some cases in positions shifted from the planar antenna toward the front surface of the timepiece. In this case, setting the minimum distance between each of the metal members and the antenna electrode to be at least 80% of the thickness of the planar antenna can suppress the influence of the metal members on the planar antenna, whereby the reception sensitivity of the planar antenna can be improved as compared with a case where the metal members are closer to the planar antenna.

In the electronic timepiece according to the aspect of the invention, it is preferable that the electric timepiece further includes at least one of a crystal oscillator, a motor, and an antimagnetic plate, and that an interior of the case is imaginarily divided into four regions by a first straight line passing through a center of the case and the center of the planar antenna and a second straight line perpendicular to the first straight line and passing through the center of the case, and at least one of the crystal oscillator, the motor, and the antimagnetic plate is disposed in a region different from a region where the power feeder is disposed.

The crystal oscillator, the motor, and the antimagnetic plate, which each have metal, is likely to affect the reception. Disposing at least one of these parts in a region different from the region where the power feeder is disposed allows suppression of the influence of the part on the power feeder because the part is separate from the power feeder, whereby the reception sensitivity of the planar antenna can be improved as compared with a case where the parts are all disposed in the same region where the power feeder is disposed.

In the electronic timepiece according to the aspect of the invention, it is preferable that the planar antenna is a patch antenna.

A patch antenna is a flat-plate-shaped antenna and is known to be a unidirectional antenna having a narrow directivity range. A circuit substrate on which the patch antenna is mounted has the function of a ground plate and therefore allows an externally incident radio electric wave to be reflected off the circuit substrate and guided to the antenna. The antenna can therefore receive not only the radio electric wave directly incident on the antenna but the radio electric wave reflected off the circuit substrate and indirectly incident on the antenna. Using the patch antenna can therefore improve the reception performance of the antenna.

In the electronic timepiece according to the aspect of the invention, it is preferable that the electric timepiece further includes a circuit substrate on which the planar antenna and a reception IC for the planar antenna are mounted, and that a wiring line that connects the power feeder of the planar antenna to the reception IC linearly extends along the circuit substrate.

A wiring line through which a high-frequency signal, such as a satellite signal, is transmitted tends to be affected by noise when a straight portion and a bent portion of the wiring line greatly differs from each other in terms of the width of the wiring line pattern, for example, in the case where the wiring line is bend by 90 degrees and the characteristic impedance of the wiring line also greatly changes. Therefore, when the wiring line from the power feeder to the reception IC can extends entirely linearly, the influence of noise on the wiring line can be minimized.

Another aspect of the invention is directed to an electronic timepiece including a case, a dial disposed in the case, a planar antenna that is disposed in the case and on the side facing a rear surface of the dial and receives a circularly polarized wave, a controller that activates the planar antenna, and a first band and a second band connected to a 12-o'clock side and a 6-o'clock side of the case, respectively. The planar antenna includes an antenna electrode having a degeneracy separator and a power feeder. The power feeder is disposed within a first angular range or a second angular range with respect to a center of the planar antenna. A reference line is defined in a plane containing a dial-side surface of the planar antenna, the reference line having an origin that coincide with the center of the planar antenna, parallel to a longitudinal direction of the first and second bands, and extending from the origin toward the first band, the first angular range is a range from 45 to 135 degrees measured from the reference line clockwise around the origin, and the second angular range is a range from 45 to 135 degrees measured from the reference line counterclockwise around the origin.

Also in the aspect of the invention, since the power feeder of the planar antenna is disposed within the first angular range (90-degree angular range from 45 to 135 degrees measured clockwise from the reference line) or in the second angular range (90-degree angular range from 45 to 135 degrees measured counterclockwise from the reference line) with respect to the center of the planar antenna, the directivity of the electronic timepiece in the side surface direction can be set within the 90-degree angular range around the 3-to-9-o'clock direction. The thus configured planar antenna readily receives a signal from a satellite located in the zenith direction, whereby the satellite signal reception sensitivity can be improved. Therefore, even when the electronic timepiece automatically starts satellite signal reception during the user's outdoor walking, the probability of successful satellite signal reception can be increased. When the probability of successful reception increases, the internal time can be reliably automatically corrected. An electronic timepiece that can improve the accuracy of displayed time and provides a high degree of convenience can therefore be provided.

### BRIEF DESCRIPTION OF THE DRAWINGS

Embodiments of the invention will be described with reference to the accompanying drawings, wherein like numbers reference like elements.

FIG. 1 is a schematic view showing an electronic timepiece according to a first embodiment of the invention.

FIG. 2 is a front view showing the front side of the electronic timepiece.

FIG. 3 is a rear view showing the rear side of the electronic timepiece.

FIG. 4 is a cross-sectional view of the electronic timepiece.

FIG. 5 is a cross-sectional view of the electronic timepiece.

FIG. 6 is a plan view showing key parts of a movement of the electronic timepiece.

FIG. 7 is an exploded perspective view showing the key parts of the movement of the electronic timepiece.

FIG. 8 is a perspective view showing a planar antenna incorporated in the electronic timepiece.

FIG. 9 shows the rear surface of the planar antenna.

FIG. 10 is a characteristic diagram showing an XY-direction pattern of radiation from the planar antenna.

FIG. 11 shows the orientation of the electronic timepiece in a state in which a user who wears the electronic timepiece walks.

FIG. 12 is a diagrammatic view showing the arrangement in an experiment on influence of a metal member on the planar antenna.

FIG. 13 shows graphs illustrating the relationship between the distance from the planar antenna to a metal member and the amount of frequency shift.

FIG. 14 is a block diagram showing the circuit configuration of the electronic timepiece.

FIG. 15 is a flowchart showing automatic reception performed by the electronic timepiece.

FIG. 16 is a front view of an electronic timepiece according to a second embodiment of the invention.

FIG. 17 is a plan view showing key parts of a movement according to a third embodiment of the invention.

FIG. 18 is a cross-sectional view of an electronic timepiece according a variation of the invention.

FIG. 19 is a cross-sectional view of an electronic timepiece according another variation of the invention.

FIG. 20 is a perspective view showing a planar antenna according to another variation of the invention.

### DESCRIPTION OF EXEMPLARY EMBODIMENTS

### First Embodiment

An electronic timepiece 1 according to a first embodiment of the invention will be described below with reference to the drawings. The present embodiment will be described on the assumption that the side facing a cover glass plate 31 of the electronic timepiece 1 is the front side (upper side) and the side facing a case back 12 is the rear side (lower side).

The electronic timepiece 1 according to the present embodiment is configured to be capable of receiving satellite signals from a plurality of position information satellites S, such as GPS satellites and quasi-zenith satellites, which go along a predetermined orbit around the earth up in the sky, to acquire satellite time information and correcting internal time information, as will be described later. The electronic timepiece 1 further includes, as satellite signal reception capability, not only of a manual reception capability of starting the reception when a user operates a button, but automatic reception capability of automatically starting the reception when a predetermined condition is satisfied.

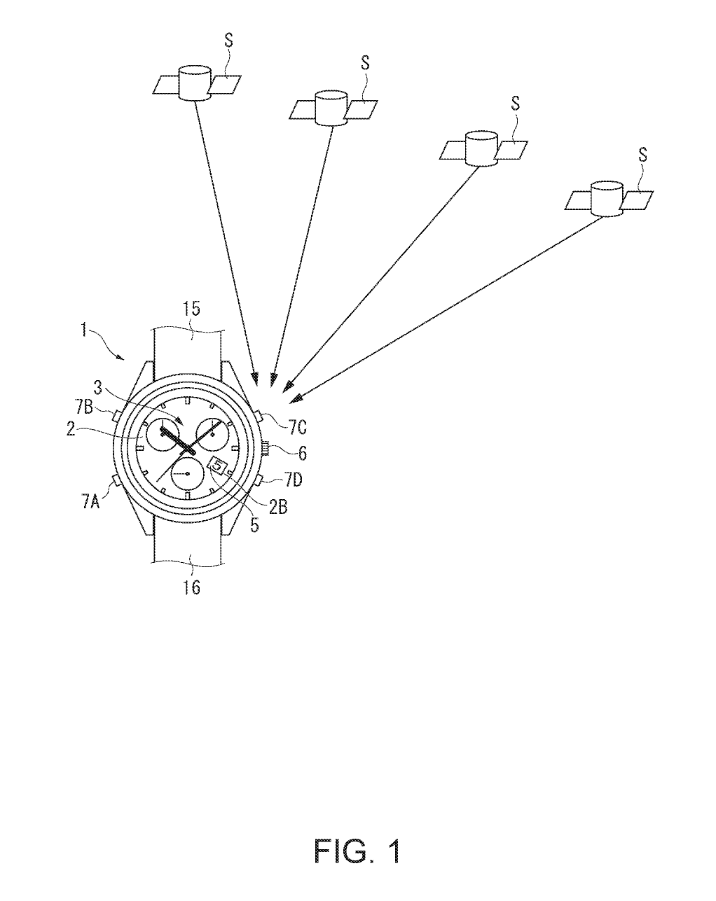

The electronic timepiece 1 includes an exterior case 10, which accommodates a dial 2, a movement 20, a planar antenna 40, a secondary battery 24, and other components, as shown in FIGS. 1 to 5. The electronic timepiece 1 further includes a crown 6 and four buttons 7A, 7B, 7C, and 7D, which are externally operated, and bands connected to the exterior case 10. The bands are formed of a first band 15, which is connected to the 12-o'clock side of the exterior case 10, a second band 16, which is connected to the 6-o'clock side of the exterior case 10, and a clasp that is not shown. The first band 15 and the second band 16 are each a metal band including an end piece made of titanium or any other metal and attached to the exterior case 10 and a plurality of small blocks. Each of the bands may not be limited to a metal band and may instead be a leather band or a resin band.

The dial 2 is formed of a non-electrically-conductive member made, for example, of polycarbonate or and formed in a disc-like shape. An indicating hand shaft 3A is disposed at the center of the dial 2 in a plan view, and indicating hands 3 (second hand 3B, minute hand 3C, and hour hand 3D) are attached to the indicating hand shaft 3A.

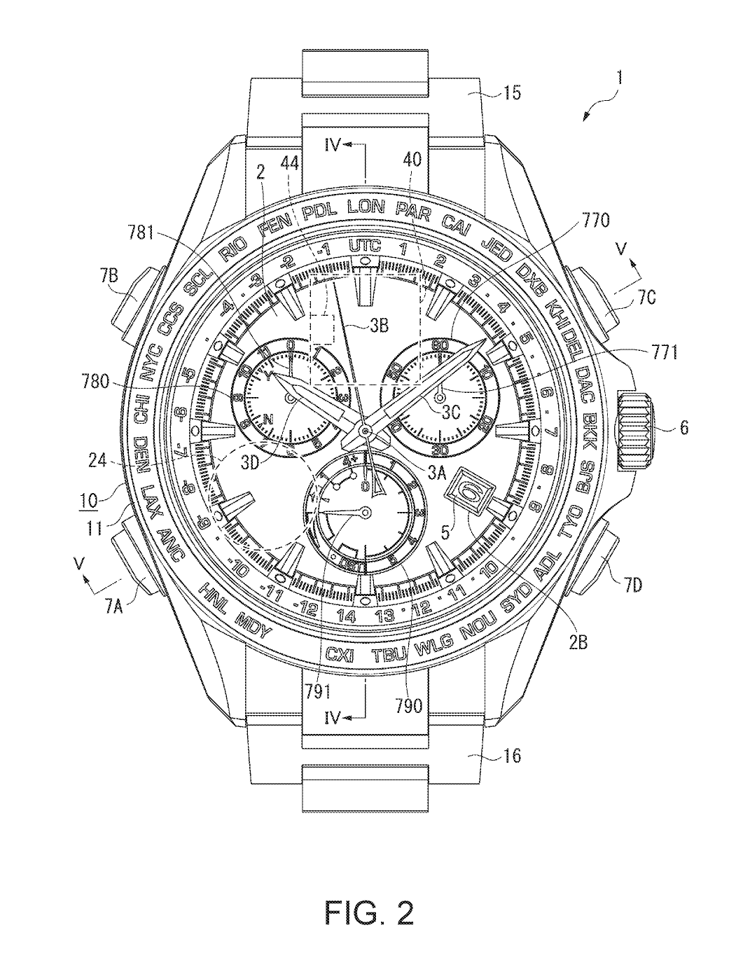

The dial 2 has three small windows (sub-dials). That is, as shown in FIG. 2, with respect to the center of the dial 2 in the plan view where the indicating hand shaft 3A is provided, a circular first small window 770 and an indicating hand 771 are provided in a 2-o'clock position, a circular second small window 780 and an indicating hand 781 are provided in a 10-o'clock position, and a circular third small window 790 and an indicating hand 791 are provided in a 6-o'clock position.

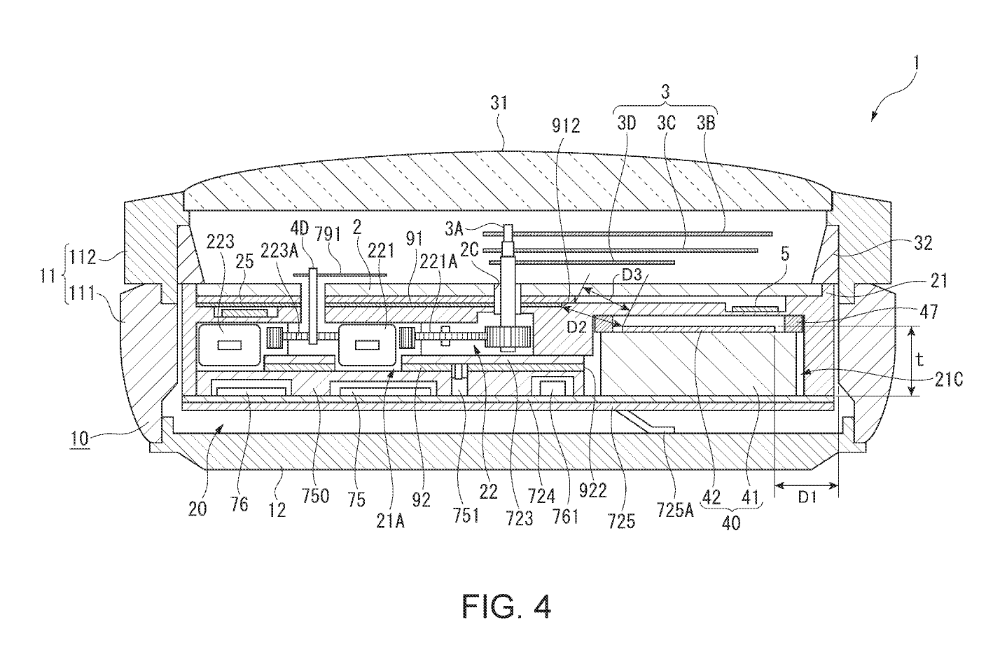

Further, a rectangular date window 2B is provided in a 4-o'clock position with respect to the center of the dial 2 in the plan view. A date indicator 5 is disposed on the side facing the rear surface of the dial 2, as also shown in FIG. 4, and the date indicator 5 is visible through the date window 2B. Further, the dial 2 is further provided with a through hole 2C, through which the indicating hand shaft 3A is inserted, and through holes through which indicating hand shafts for the indicating hands 771, 781, and 791 are inserted.

In the present embodiment, the indicating hand 771 in the first small window 770 is a chronograph minute hand, and the indicating hand 781 in the second small window 780 is a ⅕ chronograph second hand. The indicating hand 791 in the third small window 790 serves both as a mode hand and a chronograph hour hand. The indicating hand 791, when it is used as the mode hand, displays whether the daylight saving time is turned on or off (DST: daylight saving time ON, ◯: daylight saving time OFF), a power indicator indicating the amount of remaining power of the secondary battery 24, and setting of the following modes: an airplane mode; a time measuring mode in which GPS time information is received and the internal time is corrected based on the GPS time information; and a position measuring mode in which GPS time information and orbit information are received and the internal time and the time zone are corrected based on the GPS time information and orbit information.

The secondhand 3B, the minute hand 3C, the hour hand 3D, the indicating hands 771, 781, and 791, and the date indicator 5 are driven via stepper motors and train wheels, as will be described later.

### Exterior Structure of Electronic Timepiece

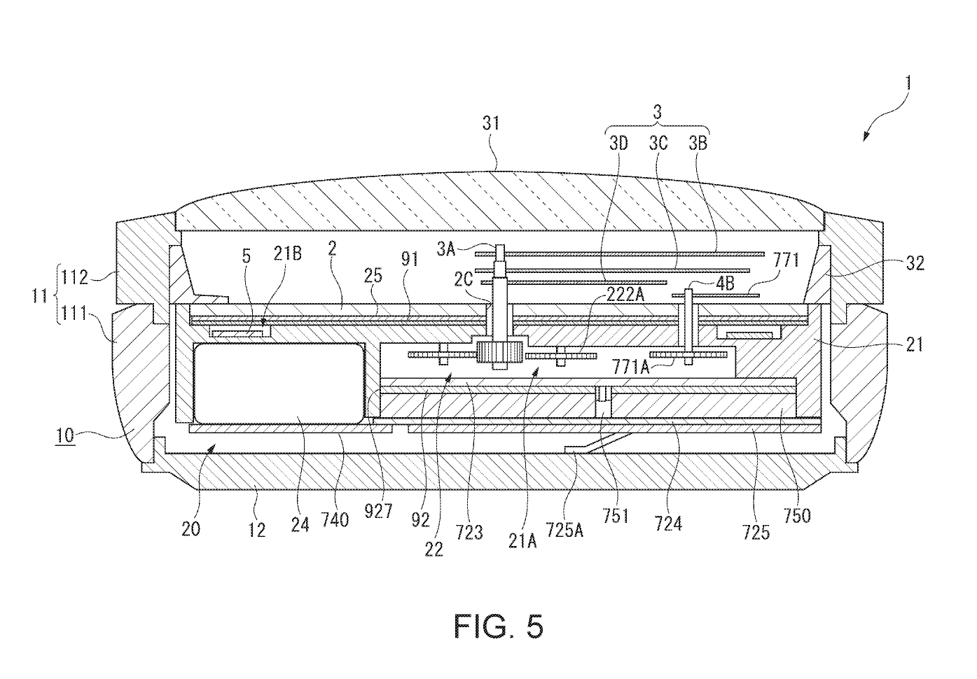

The electronic timepiece 1 includes the exterior case 10, which accommodates the movement 20, which will be described later, and other components, as shown in FIGS. 2 to 5. FIG. 4 is a cross-sectional view taken along the line IV-IV, which connects a 6-o'clock position and a 12-o'clock position on the dial 2 to each other. FIG. 5 is a cross-sectional view taken along the line V-V, which connects a 2-o'clock position and an 8-o'clock position on the dial 2 to each other.

The exterior case 10 includes a case body 11, a case back 12, and a cover glass plate 31. The case body 11 includes a barrel 111, which has a cylindrical shape, and a bezel 112, which is provided on the front side of the barrel 111.

The case back 12, which has a disc-like shape and closes the rear-side opening of the case body 11, is provided on the rear side of the case body 11. The case back 12 is connected to the barrel 111 of the case body 11 with the aid of a screw structure. In the present embodiment, the barrel 111 and the case back 12 are parts separate from each other, but not necessarily, and the barrel 111 and the case back 12 may be integrated with each other into a one-piece case.

The barrel 111, the bezel 112, and the case back 12 are each made of a metal material, such as SUS (stainless steel), a titanium alloy, aluminum, and BS (brass).

### Internal Structure of Electronic Timepiece

The internal structure of the electronic timepiece 1 that is built in the exterior case 10 will next be described.

The exterior case 10 accommodates not only the dial 2 but the movement 20, the planar antenna (patch antenna) 40, the date indicator 5, a dial ring 32, and other components, as shown in FIGS. 4 and 5.

The movement 20 includes a main plate 21, a train wheel bridge (not shown), a driver 22, which is supported by the main plate 21 and the train wheel bridge, a first circuit substrate 723, a second circuit substrate 724, the secondary battery 24, a solar cell panel 25, a first antimagnetic plate 91, and a second antimagnetic plate 92.

The main plate 21 is formed of a non-electrically-conductive member made, for example, of a plastic material. The main plate 21 includes a driver container 21A, which contains the driver 22, a date indicator placer 21B, where the date indicator 5 is placed, and an antenna container 21C, which contains the planar antenna 40.

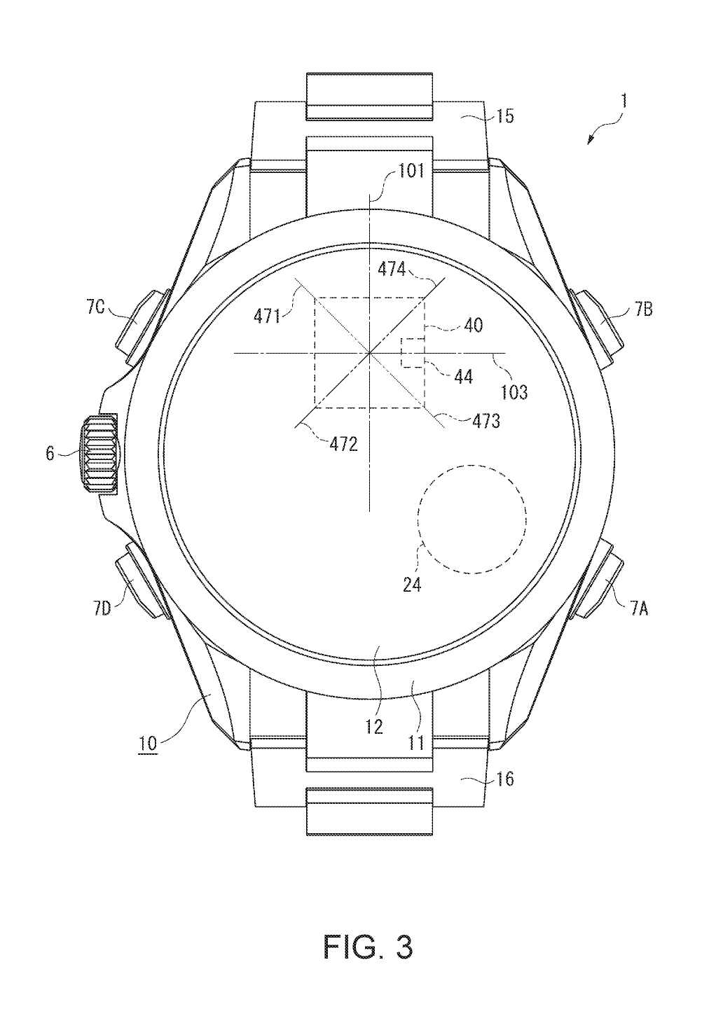

The driver container 21A and an antenna container 21C are provided on the side facing the rear surface of the main plate 21. Since the antenna container 21C is disposed in a position corresponding to 12-o'clock on the dial 2 in the plan view, the planar antenna 40 is disposed in a 12-o'clock position, as shown in FIGS. 2 and 3. Specifically, the planar antenna 40 is disposed between the indicating hand shaft 3A of the indicating hands 3 and the case body 11 and in a range from roughly the 11-o'clock position to roughly the 1-o'clock position on the dial 2. That is, the center position of the planar antenna 40 is located within a 60-degree angular range from the 11-o'clock direction to the 1-o'clock direction with respect to the center of the exterior case 10 (center of dial 2) in the plan view.

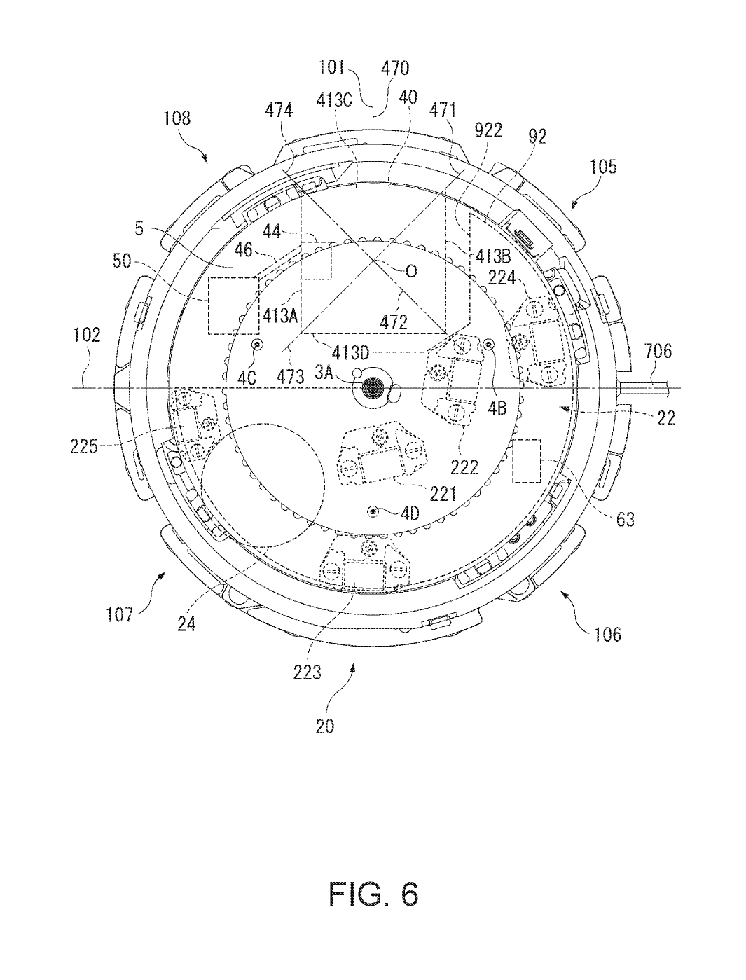

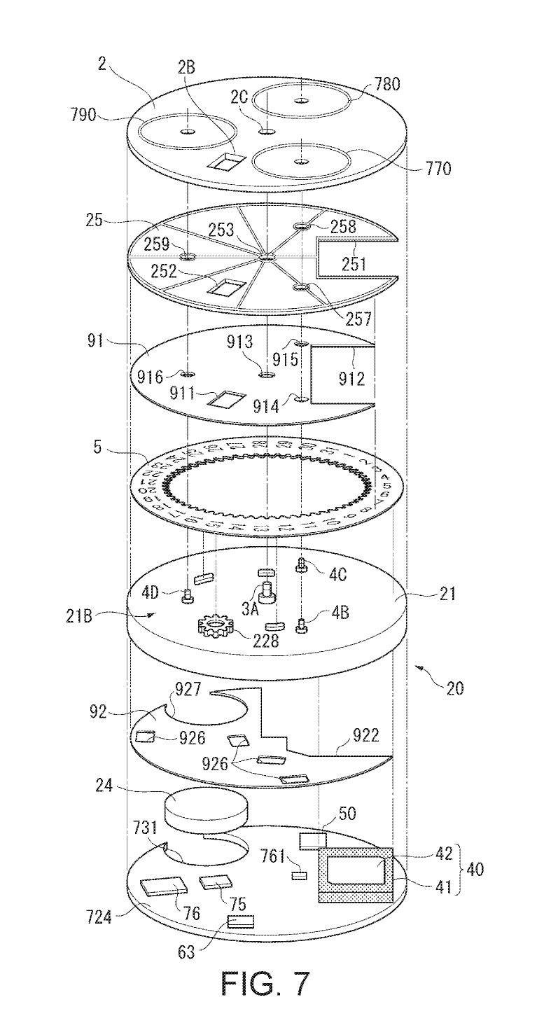

The driver 22 is contained in the driver container 21A of the main plate 21 and drives the second hand 3B, the minute hand 3C, the hour hand 3D, the indicating hands 771, 781, and 791, and the date indicator 5. That is, as shown in FIG. 6, the driver 22 includes a stepper motor 221 and a first train wheel 221A (FIG. 4), which drive the second hand 3B, a second stepper motor 222 and a second train wheel 222A (FIG. 5), which drive the minute hand 3C and the hour hand 3D, and a third stepper motor 223 and a third train wheel 223A (FIG. 4), which drive both the indicating hand 791 and the date indicator 5. The third train wheel 223A includes a date indicator driving wheel 228 (FIG. 7), which rotates the date indicator 5.

The driver 22 further includes a fourth stepper motor 224 and a fourth train wheel 771A (FIG. 5), which drive the indicating hand 771, and a fifth stepper motor 225 and a train fifth wheel (not shown), which drive the indicating hand 781.

The stepper motors 221 to 225 are disposed so as not to overlap with the planar antenna 40 in the plan view. An indicating hand shaft 4B, to which the indicating hand 771 is attached, an indicating hand shaft 4C, to which the indicating hand 781 is attached, and an indicating hand shaft 4D, to which the indicating hand 791 is attached, are each disposed in a position inside the inner circumference of the date indicator 5.

In the movement 20, a winding stem 706, which is connected to the crown 6, is disposed in the 3-o'clock position on the dial 2 in the plan view, as shown in FIG. 6, and a switch mechanism (changeover mechanism) that is not shown, such as a setting lever, is disposed around the winding stem 706.

### Antimagnetic Plate

In recent years, a large number of high-performance magnets are used in a carrying case for a mobile terminal, such as a smartphone, and it is desirable for a wristwatch to also have magnetism resistance. To cause an external magnetic field to detour around to prevent malfunction of the stepper motors 221 to 225, the first antimagnetic plate 91 and the second antimagnetic plate 92 made of a highly permeable material, such as pure iron, are disposed as to overlap with the stepper motors 221 to 225 in the plan view, as shown in FIG. 7. The stepper motors 221 to 225 each include a coil wound around a core, a stator, and a rotor. Among them, the coil portion, which is unlikely to be affected by an external magnetic field, does not necessarily need to overlap with the antimagnetic plate 91 or 92 in the plan view. The antimagnetic plates 91 and 92 therefore preferably overlap with at least part of the stepper motors 221 to 225, particularly, the stators and rotors thereof in the plan view.

The first antimagnetic plate 91 is disposed on the timepiece front surface side (side facing cover glass plate 31) of the main plate 21 and the date indicator 5 and on the rear side of the solar battery panel 25, as shown in FIGS. 4 and 5. The antimagnetic plate 91 is disposed so as to almost completely cover the front surfaces (surfaces facing dial 2) of the stepper motors 221 to 225.

The first antimagnetic plate 91 is provided with an opening 911, which is formed in a position corresponding to the date window 2B and allows the date indicator 5 to be viewed, and openings 913 to 916, in which the indicating hand shafts 3A, 4B, 4C, and 4D are disposed, as shown in FIG. 7.

The first antimagnetic plate 91 is so cut that the region where it overlaps with the planar antenna 40 in the plan view to form a cutout 912. The antimagnetic plate 91 is therefore not disposed on the side facing the front surface of the planar antenna 40, whereby the planar antenna 40 can receive an electric wave through the cutout 912 of the antimagnetic plate 91.

The second antimagnetic plate 92 is disposed on the timepiece rear surface side (side facing case back 12) of the main plate 21 and on the timepiece front surface side of the second circuit substrate 724, as shown in FIGS. 4 to 7. Specifically, the train wheel bridge (not shown) having bearings for the wheel trains is disposed on the timepiece rear surface side of the main plate 21, and the second antimagnetic plate 92 is disposed on the timepiece rear surface side of the train wheel bridge. The second antimagnetic plate 92 is therefore disposed so as to almost completely cover the rear surfaces (surfaces facing case back 12) of the stepper motors 221 to 225.

The movement 20 is now imaginarily divided into four regions (quadrants) in the plan view, as shown in FIG. 6. Specifically, the movement 20, that is, the interior of the exterior case 10 is imaginarily divided into four regions 105 to 108 by a 12-to-6-o'clock-direction first straight line 101, which passes through the center of the movement (center of exterior case 10 and dial 2) and the center of the planar antenna 40 in the plan view, and a 3-to-9-o'clock-direction second straight line 102, which is perpendicular to the first straight line 101 and passes through the center of the movement 20 in the plan view.

The region 105 is an upper right range in FIG. 6, that is, the range from 12-o'clock to 3-o'clock on the dial 2, and the other regions 106 to 108 are arranged clockwise with respect to the region 105.

The second antimagnetic plate 92 is provided with a cutout 922 so as not to interfere with the planar antenna 40. The second antimagnetic plate 92 is therefore shaped in the region 105 so as to cover the portion that does not overlap with the planar antenna 40 and is shaped in the regions 106 to 107 so as to have a roughly semicircular shape. The second antimagnetic plate 92, which has the cutout 922, therefore does not cover the region 108.

In the region 108 are disposed a power feeder 44 of the planar antenna 40 and a receiver (reception IC) 50, as will be described later. Further, none of the stepper motors 221 to 225 and a crystal oscillator 63 is disposed in the region 108.

The second antimagnetic plate 92 is provided with openings 926, in which the coils of the stepper motors 221 to 224 are disposed, and a cutout 927, which has a roughly circular shape and in which the secondary battery 24 is disposed.

Consider two regions (semicircular segments) into which the movement 20 is imaginarily divided by the second straight line 102 (regions 105, 108 and regions 106, 107), and note that the planar antenna 40 and the secondary battery 24 are disposed in different ones of the two regions.

### Circuit Substrate

In the electronic timepiece 1 according to the present embodiment are disposed two circuit substrates, the first circuit substrate 723 for timepiece drive control shown in FIGS. 4 and 5 (not shown in FIG. 7) and the second circuit substrate 724 for GPS reception shown in FIGS. 4, 5, and 7.

The first circuit substrate 723 is disposed between the main plate 21 and the second antimagnetic plate 92, provided, for example, with wiring lines electrically continuous with the coils of the stepper motors 221 to 225, and connected to the second circuit substrate 724 via a connector 751.

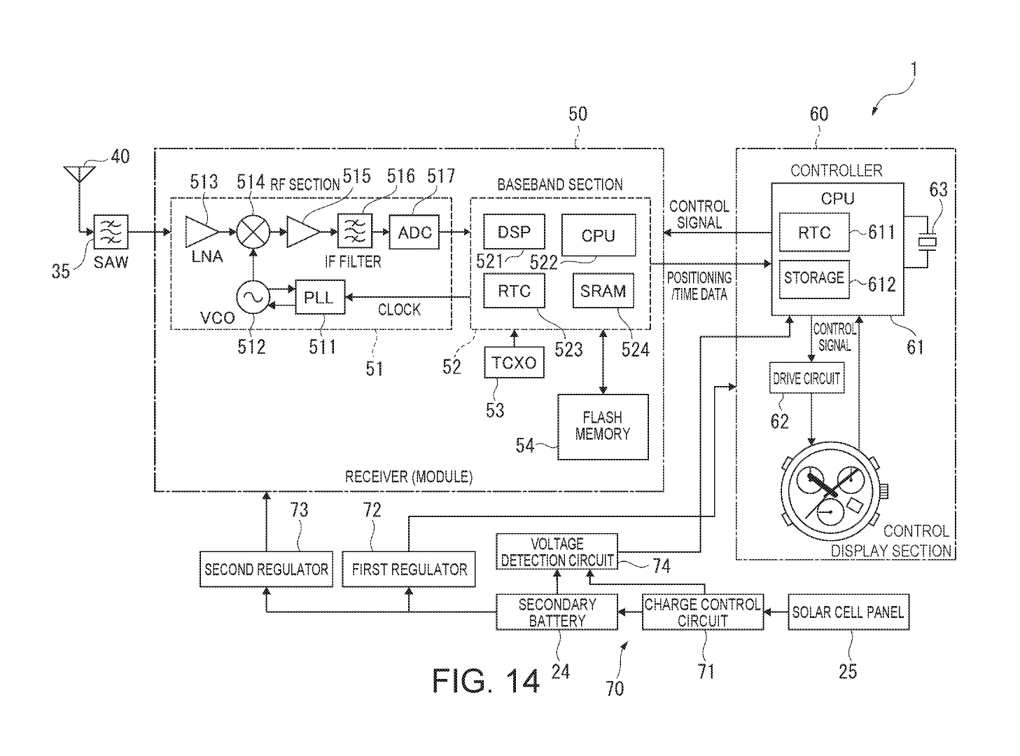

On the first circuit substrate 723 are mounted a timepiece control IC (CPU) 61 (FIG. 14), which receives a signal from the second circuit substrate 724 for reception and controls the motors, a timepiece drive control IC (drive circuit) 62 (FIG. 14), and other components.

The second circuit substrate 724 is disposed on the rear surface of the second antimagnetic plate 92 via a spacer 750 (not shown in FIG. 7). The second circuit substrate 724 is formed in a roughly circular shape in the plan view and provided with a roughly circular cutout 731, in which the secondary battery 24 is disposed, as also shown in FIG. 7. Disposing the secondary battery 24 in the cutout 731 allows reduction in the thickness of the electronic timepiece 1. On the front surface of the second circuit substrate 724 are mounted the planar antenna (patch antenna) 40, the receiver (reception device, reception IC, and GPS module), which processes satellite signals received from the GPS satellites S, a power supply IC 75, a memory IC 76, a chip device 761, the crystal oscillator 63, and other components. The memory IC 76 is formed of a flash memory and stores a firmware program for GPS reception and time zone data for identifying a time zone from position information calculated in a measured position receiving process.

The spacer 750 protects the ICs and other components. To this end, the ICs are desirably located in positions at least different from the positions immediately below the indicating hand shafts 3A, 4B, 4C, and 4D. A circuit retaining plate 725 is disposed on the rear surface of the second circuit substrate 724.

The circuit retaining plate 725 is integrated with a case back electrical continuity spring 725A for allowing electrical continuity with the case back 12. The case back electrical continuity spring 725A is formed of a plurality of case back electrical continuity springs 725A formed on the circuit retaining plate 725.

A battery terminal plate 740 is further disposed on the case back side of the secondary battery 24, as shown in FIG. 5. The battery terminal plate 740 is electrically continuous with the second circuit substrate 724. Further, although not shown, the solar cell panel 25 is electrically continuous with the second circuit substrate 724 so that electric power generated by the solar cell panel 25 can charge the secondary battery 24 via the second circuit substrate 724.

### Secondary Battery

The secondary battery 24 is a button-shaped lithium-ion battery formed in a circular shape in the plan view, as shown in FIGS. 5 to 7, and supplies the driver 22, the receiver 50, and other components with electric power. The secondary battery 24 is provided in the cutout 731 of the second circuit substrate 724 and disposed so as not to overlap with the planar antenna 40, the receiver 50, or the power supply IC 75, specifically, disposed in an 8-o'clock position with respect to the center of the dial 2 in the plan view.

### Solar Cell Panel

The solar cell panel 25 has a front surface electrode and a rear surface electrode as an electrode section. The front surface electrode is formed of a transparent electrode made, for example, of ITO (indium tin oxide) to allow light to pass therethrough. In the solar cell panel 25, a thin film made of an amorphous silicon semiconductor is formed as a power generating layer on a base formed of a resin film.

The frequency of a GPS satellite signal is about 1.5 GHz, which is a high frequency. A high-frequency electric wave differs from a standard long-wavelength electric wave received by a radio wave timepiece in that even the thin transparent electrode of the solar panel attenuates the high-frequency electric wave and degrades the antenna characteristics accordingly. To avoid the problem, the solar cell panel 25, which is formed in a disc-like shape, is provided with a cutout 251 formed in a portion that overlaps with the planar antenna 40 in the plan view, as shown in FIG. 7. The solar cell panel 25 is disposed on the front side of the main plate 21 but is not disposed on the front side of the planar antenna 40. The planar antenna 40 can therefore receive an electric wave through the cutout 251 of the solar cell panel 25.

The solar cell panel 25 is provided with an opening 252, which overlaps with the date window 2B of the dial 2 in the plan view, and holes 253 and 257 to 259, through which the indicating hand shafts 3A and 4B to 4D are inserted.

Further, the solar cell panel 25 is divided into a plurality of cells, and the cells are connected in series to each other. The solar cell panel 25 in the present embodiment has eight solar cells, and the solar cells are connected in series to each other, as shown in FIG. 7. The electromotive voltage produced by each of the solar cells is at least about 0.6V. Connecting the eight solar cells in series to each other therefore provides an electromotive voltage of at least about 4.8 V, which is about 0.6 V multiplied by 8. The lithium-ion secondary battery 24, which is a large electromotive voltage battery, can therefore be charged, whereby a device that consumes a large amount of current, such as a GPS receiver (GPS module), can be built in the timepiece.

### Date Indicator

The date indicator 5, which is a calendar wheel which is formed in a ring-like shape and on which dates are displayed, is disposed in the date indicator placer 21B of the main plate 21. The date indicator 5 is formed of a non-electrically-conductive member made, for example, of a plastic material. The date indicator 5 overlaps with at least part of the planar antenna 40 in the plan view. The calendar wheel is not limited to a date indicator and may instead be a day indicator that displays the seven days of a week or a month indicator that displays the months.

### Dial

The dial 2 is so disposed on the side facing the front surface of the main plate 21 as to cover the front sides of the solar cell panel 25 and the date indicator 5. The dial is made, for example, of a plastic material having non-electrical-conductivity and translucency that allows transmission of at least part of light.

Abbreviations and other letters can be provided on the front surface of the dial 2, which overlaps with the planar antenna 40 in the plan view. In this case, to improve the reception performance of the planar antenna 40, it is preferable that parts provided on the front surface of the dial 2, such as abbreviations, are not made of a metal but are formed of a non-electrically-conductive member made, for example, of a plastic material. On the other hand, the third small window 790 and abbreviations that do not overlap with the planar antenna 40 in the plan view can be metal members.

The dial 2 is has translucency. Therefore, when the user views the timepiece from the side facing the front surface thereof, the solar cell panel 25, which is disposed on the side facing the rear surface of the dial 2, is visible through the dial 2. The perceived color of the dial 2 in the region where the solar cell panel 25 is disposed therefore differs from that in the region where no solar cell panel 25 is disposed. The dial 2 may have an appearance accent that causes the color difference to be less noticeable.

Further, since the solar cell panel 25 is provided with the cutout 251, the color tone of the dial 2 in the portion that overlaps with the cutout 251 is perceived differently from the color tone of the other portion in some cases. To avoid the color tone difference, a plastic sheet having the color of the solar cell panel 25 (dark blue or violet, for example) may underlie the solar cell panel 25, or in place of the cutout 251, which is a full cutout of the solar cell panel 25, only a portion of an electrode layer, which blocks electric waves, may be removed, that is, only the portion that overlaps with the planar antenna 40 in the plan view may be removed, but a resin film layer, which is a base material, may be left for color tone adjustment.

### Dial Ring

The dial ring 32, which is a ring member made of a synthetic resin (ABS resin, for example), which forms a non-electrically-conductive member, is provided on the side facing the front surface of the dial 2. The dial ring 32 is disposed along the circumference of the dial 2 and has an inclining inner circumferential surface (conical or chamfered surface), and markings, such as hour letter marks and world time differences, are printed on the inclining surface. The dial ring 32, when it is molded by using a plastic material, allows the electronic timepiece 1 to ensure the reception performance and can be formed in a complex shape for improvement in exterior appearance.

### Planar Antenna

The planar antenna 40, which is a patch antennal (microstrip antenna), is disposed in the antenna container 21C of the main plate 21. The planar antenna 40 receives satellite signals from the GPS satellites S.

The planar antenna 40 does not overlap with the case body 11 (barrel 111 and bezel 112), the solar cell panel 25, or the antimagnetic plate 91 or 92 but overlaps with the date indicator 5, the dial 2, and the cover glass plate 31, which are each formed of a non-electrically-conductive member, in the plan view. That is, in the electronic timepiece 1, the parts that are located on the timepiece front surface side of the planar antenna 40 and the overlap with the planar antenna 40 in the plan view are each formed of a non-electrically-conductive member.

The satellite signals that propagate toward the timepiece front surface therefore pass through the cover glass plate 31, further pass through the dial 2, the date indicator 5, and the main plate 21 without being blocked by the case body 11, the antimagnetic plate 91 or 92, or the solar cell panel 25, and impinge on the planar antenna 40. The second hand 3B, the minute hand 3C, the hour hand 3D, the indicating hand 771, and the indicating hand 781, which are each made of a metal and each overlap with the planar antenna 40 only by a small area, do not compromise the reception of the satellite signals but are each preferably formed of a non-electrically-conductive member from the viewpoint of further avoidance of the blockage of the satellite signals.

The GPS satellites S each transmit a right-handed circularly polarized satellite signal. The planar antenna 40 in the present embodiment is therefore formed of a patch antenna that excels in a circularly polarized wave characteristic.

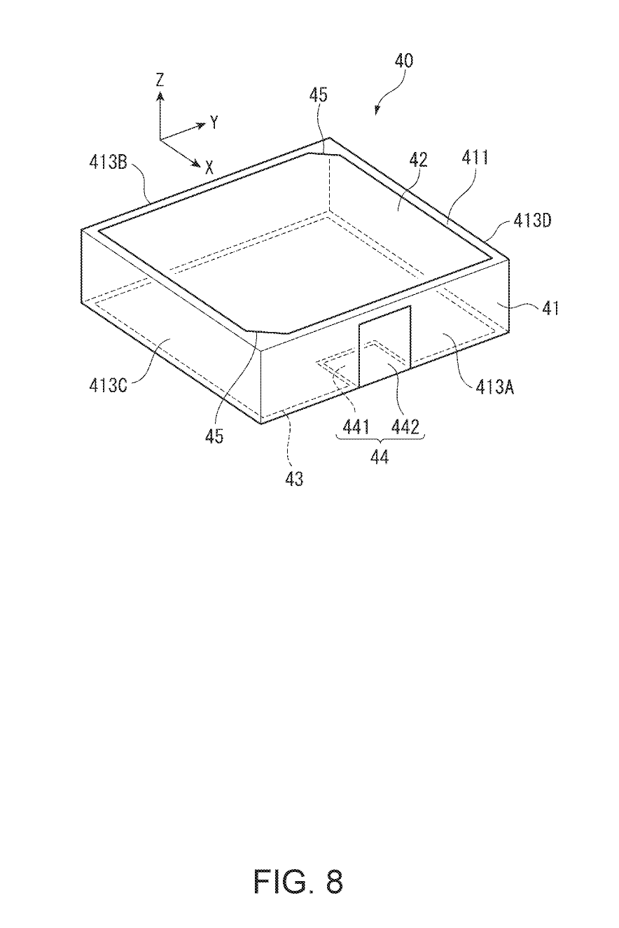

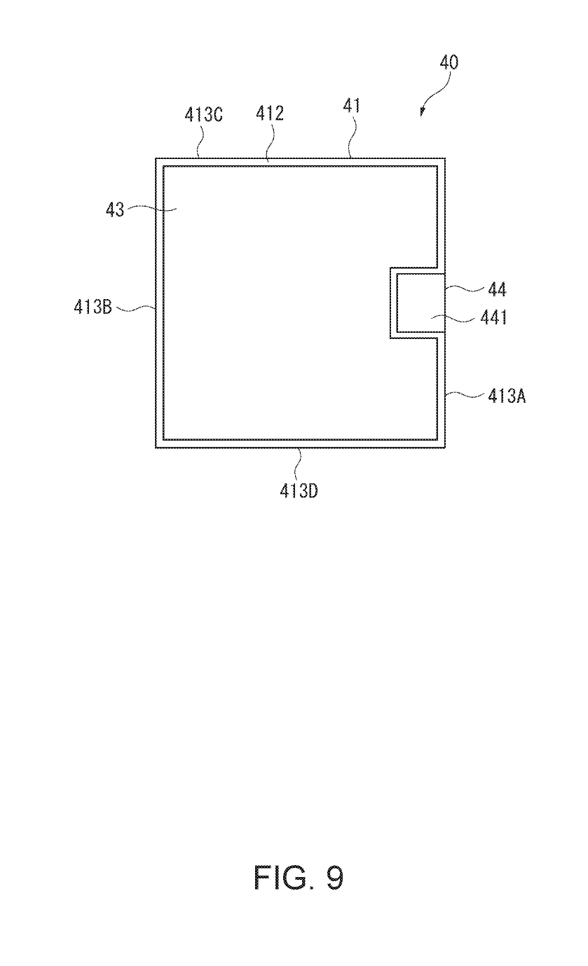

The planar antenna 40 is a surface-mounted patch antenna formed of a dielectric base member 41 on which an antenna electrode section 42, a GND electrode 43, and the power feeder 44 are layered, as shown in FIGS. 8 and 9. The power feeder 44 is a band-shaped strip electrode including a power feeding electrode 441 and a side surface electrode 442. A box-shaped patch antenna resonates when one side of the antenna electrode section 42 has a length equal to half the wavelength of the polarized wave to be received, and a circular patch antennal resonates when the diameter of the circular shape is equal to the wavelength multiplied by about 0.58. However, since the planar antenna 40 includes the dielectric base member 41, the size of the planar antenna 40 can be reduced based on a wavelength shortening effect provided by the dielectric material.

The dielectric base member 41 is made of a dielectric material, such as a ceramic material, and formed in a box-like shape. The dielectric base member 41 has a front surface 411, which faces the main plate 21 and the dial 2, and a rear surface 412, which faces the second circuit substrate 724. The dielectric base member 41 further has four side surfaces, a first side surface 413A, a second side surface 413B, a third side surface 413C, and a fourth side surface 413D. The first side surface 413A and the second side surface 413B are disposed so as to face each other, and the third side surface 413C and the fourth side surface 413D are disposed so as to face each other, as shown in FIG. 9.

The front surface 411 of the dielectric base member 41 is provided with the antenna electrode section (radiation electrode section) 42.

The antenna electrode section 42 is formed in a rectangular shape in the plan view, and degeneracy separators 45 are formed at a pair of diagonal portions of the antenna electrode section 42 to receive a circularly polarized wave. The degeneracy separators 45 disturb the balance between two polarized waves that are produced by the antenna electrode section 42 and perpendicular to each other and may each, for example, be a cutout or a protrusion. In the present embodiment, the degeneracy separators 45 are formed by cutting off corners of the antenna electrode section 42.

The power feeding electrode 441 of the power feeder 44 is formed on the rear surface 412 of the dielectric base member 41, and the side surface electrode 442 is formed on the first side surface 413A of the dielectric base member 41. The power feeding electrode 441 and the side surface electrode 442 are formed physically and electrically continuous with each other.

The side surface electrode 442 is close to and hence capacitively coupled to the antenna electrode section 42 in a central portion of the first side surface 413A. A satellite electric wave received by the antenna electrode section 42 is transmitted to the side surface electrode 442 via the capacitive coupling and can be extracted from the power feeding electrode 441.

The GND electrode 43 is insulated from the power feeding electrode 441 on the rear surface 412 of the dielectric base member 41 and is a solid electrode that covers the portion excluding the power feeding electrode 441, as shown also in FIG. 9.

In the present embodiment, the position where the power feeder 44 is disposed is set as follows.

A first angular range and a second angular range are imaginarily set (defined) with respect to the center O of the planar antenna 40, as shown in FIG. 6.

The first angular range is an angular range from the 1.5-o'clock direction to the 4.5-o'clock direction provided that the direction from the center O of the planar antenna 40 is taken to be analogous to the direction from the center of the dial 2 (movement 20) toward the markings on the dial 2. The 1.5-o'clock direction is the direction inclining by 45 degrees with respect to the first straight line 101 and the second straight line 102, which pass through the center of the dial 2, and is therefore the direction of an imaginary line 471, which extends from the center O of the planar antenna 40 toward the corner where the second side surface 413B and the third side surface 413C intersect each other in FIG. 6. Similarly, the 4.5-o'clock direction is the direction of an imaginary line 472, which extends from the center O of the planar antenna 40 toward the corner where the second side surface 413B and the fourth side surface 413D intersect each other.

The second angular range is an angular range from the 7.5-o'clock direction to the 10.5-o'clock direction provided that the direction from the center O of the planar antenna 40 is taken to be analogous to the direction from the center of the dial 2 (movement 20) toward the markings on the dial 2. The 7.5-o'clock direction is the direction of an imaginary line 473, which extends from the center O of the planar antenna 40 toward the corner where the first side surface 413A and the fourth side surface 413D intersect each other in FIG. 6. The 10.5-o'clock direction is the direction of an imaginary line 474, which extends from the center O of the planar antenna 40 toward the corner where the first side surface 413A and the third side surface 413C intersect each other.

The first and second angular ranges are therefore each an angular range having a central angle of 90 degrees. In the present embodiment, the power feeder 44 is disposed within the second angular range. Further, the power feeder 44 is disposed on a straight line 103 (FIG. 3), which is parallel to the second straight line 102, with respect to the center O of the planar antenna 40 and is therefore disposed in a 9-o'clock position in the second angular range.

The first and second angular ranges can also be described as follows: Consider a flat plane A parallel to the dial 2 and containing the upper surface (front surface) 411 of the planar antenna 40. In the plane A, define a reference line 470 to be the straight line that has an origin that coincides with the center O of the planar antenna 40 in the plan view, is parallel to the longitudinal direction of the first band 15 and the second band 16, which are connected to the exterior case 10, and extends from the origin toward the first band 15. The reference line 470 is a straight line that has an origin that coincides with the center O and overlaps with the first straight line 101. The first angular range is the range from 45 to 135 degrees measured from the reference line 470 clockwise around the origin. The second angular range is the range from 45 to 135 degrees measured from the reference line 470 counterclockwise around the origin. In the present embodiment, the power feeder 44 is disposed in a position angularly shifted by 90 degrees counterclockwise from the reference line 470.

The planar antenna 40 can be manufactured as follows: First, a material primarily containing barium titanate having a dielectric constant ranging from about 60 to 120 is molded by a pressing machine into a target form, followed by firing to produce a ceramic material that will form the dielectric base member 41 of the antenna. A paste material primarily containing silver (Ag) or any other substance is screen-printed or otherwise placed on the rear surface 412 of the dielectric base member 41 to form the GND electrode 43, which forms the ground electrode of the antenna.

The antenna electrode section 42, which determines the frequency at which the antennal operates and the polarized wave of a signal to be received, is formed on the front surface 411 of the dielectric base member 41 in the same method in accordance with which the GND electrode 43 is formed. The antenna electrode section 42 is so formed as to be one-size smaller than the front surface of the dielectric base member 41, so that an exposed surface where no antenna electrode section 42 is layered but the dielectric base member 41 is exposed is provided on the front surface of the dielectric base member 41 but around the antenna electrode section 42.

The power feeding electrode 441 and the side surface electrode 442 of the power feeder 44 are formed on the rear surface 412 and the first side surface 413A of the dielectric base member 41, respectively, in the same method in accordance with which the GND electrode 43 is formed.

The dielectric base member 41, for example, has a roughly square front-side shape, has each side having a dimension of about 11 mm, and has a thickness of 3 mm. The antenna electrode section 42, for example, has a roughly square front-side shape and has each side having a dimension ranging from about 8 to 9 mm.

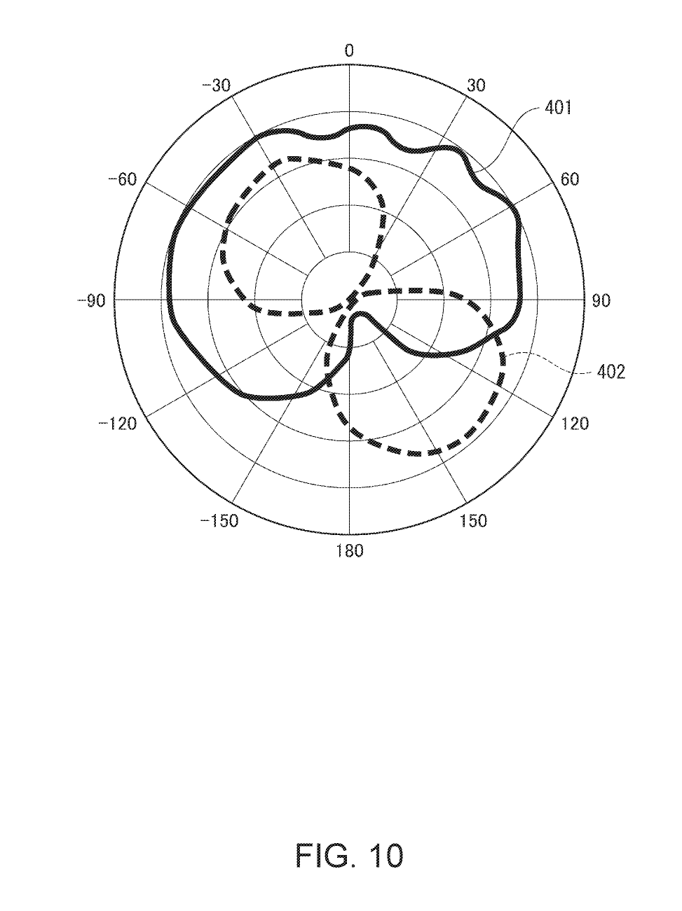

FIG. 10 is a characteristic diagram showing the pattern of radiation from the planar antenna 40. The characteristic diagram shows the characteristic of the radiation pattern on the following assumption: the direction from the position of the center of the antenna electrode section 42 of the planar antenna 40 in the plan view toward the side surface electrode 442, that is, the first side surface 413A, where the power feeder 44 is formed, is an axis X; the direction perpendicular to the axis X on the front surface of the antenna electrode section 42 is an axis Y; the direction perpendicular to the axes X and Y is an axis Z; and the direction of the axis X is the 3-o'clock or 9-o'clock direction, as shown in FIG. 8. That is, FIG. 10 is a characteristic diagram showing the radiation pattern in the directions XY in a case where the power feeder 44 of the planar antenna 40 is disposed in a 3-o'clock or 9-o'clock position.

Disposing the power feeder 44 in a 3-o'clock or 9-o'clock position indicates that the power feeder 44 is disposed in a position on the direction toward the 3-o'clock or 9-o'clock marking provided that the direction from the center of the planar antenna 40 in the plan view to the position where the power feeder 44 is disposed is taken to be analogous to the direction from the center of the dial 2 in the plan view. The planar antenna 40 shown in FIGS. 2, 3, and 6 is therefore so disposed that the power feeder 44 is disposed in a 9-o'clock position.

In FIG. 10, the solid line 401 represents the right-handed polarized wave characteristic of the antenna, and the dotted line 402 represents the left-handed polarized wave characteristic of the antenna. Further, in FIG. 10, 0 degrees correspond to the 12-o'clock direction, 90 degrees correspond to the 3-o'clock direction, 180 (−180) degrees correspond to the 6-o'clock direction, and −90 degrees correspond to the 9-o'clock direction. Therefore, in the right-handed polarized wave characteristic, the directivity in the 3-to-9-o'clock direction is provided.

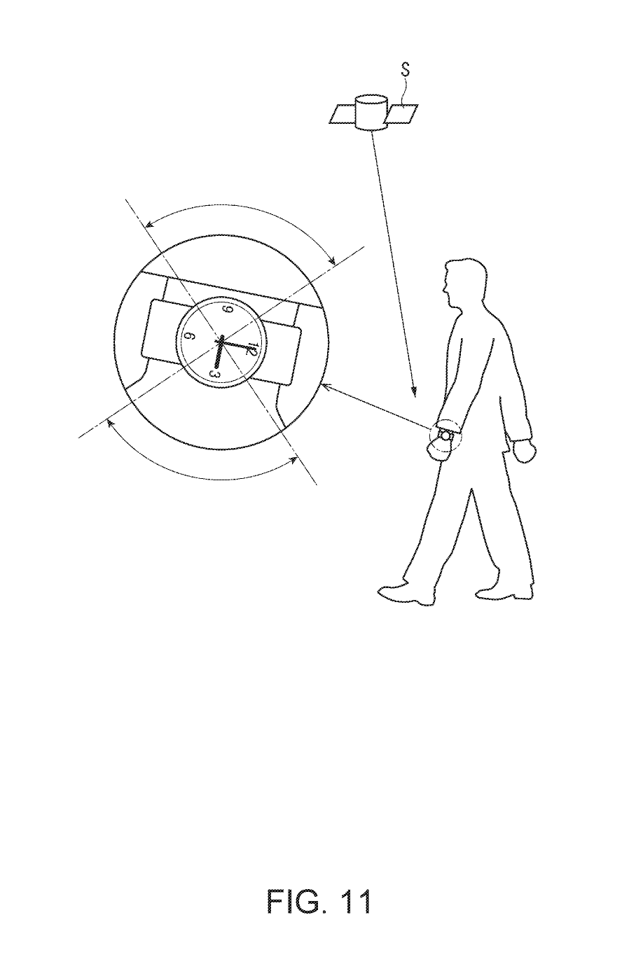

In a case where the automatic reception is performed in a state in which a user who wears the electronic timepiece 1 walks, the 9-o'clock direction of the electronic timepiece 1 roughly coincides with the zenith direction when the user wears the electronic timepiece 1 around the left wrist, and the 3-o'clock direction of the electronic timepiece 1 roughly coincides with the zenith direction when the user wears the electronic timepiece 1 around the right wrist, as shown in FIG. 11. The satellite signals in the zenith direction can therefore be readily received as long as the directivity in the 3-to-9-o'clock direction is provided, as in the case of the planar antenna 40 in the present embodiment.

The planar antenna 40 is mounted on the front surface of the second circuit substrate 724 and electrically connected to an antenna GPS module, which is the receiver 50 mounted on the second circuit substrate 724, via a power feed line 46. The power feed line 46 is a wiring line formed on the second circuit substrate 724 and is wired so that the power feeder 44 and the receiver 50 are connected to each other along an entirely straight line in the present embodiment, as shown in FIG. 6. The power feed line 46 is therefore obliquely extracted from the power feeding electrode 441 of the power feeder 44 roughly in the 8-o'clock direction. The power feed line 46 is not limited to the wiring line that connects the power feeder 44 and the receiver 50 to each other along a straight line. To transmit a high-frequency signal, however, it is preferable to employ a wiring line that is as straight as possible. Therefore, in a case where the wiring line needs to be bent, the wiring line should not be bent by 90 degrees but may be bent, for example, by 45 degrees. When the wiring line is bent by 90 degrees, the width of the wiring line pattern in the 90-degree bent portion greatly changes from the width of the wiring line pattern in the straight portion, and the characteristic impedance also greatly changes, so that the wiring line is readily affected by noise.

Further, the GND electrode 43 of the planar antenna 40 is electrically continuous with a ground portion of the receiver 50 via a ground pattern on the second circuit substrate 724, and the second circuit substrate 724 therefore functions as a ground plate (ground plane). Further, the ground portion of the receiver 50 is electrically continuous with the barrel 111 and the case bask 12, which are each made of a metal, via the ground pattern on the second circuit substrate 724, whereby the barrel 111 and the case back 12 can also be used as the ground plane.

The planar antenna 40 is disposed in the antenna container 21C by fixing the second circuit substrate 724 to the main plate 21, as shown in FIG. 4. Since the dielectric base member 41 of the planar antenna 40 is made of a ceramic material and is therefore brittle, a cushion material 47, such as sponge, is interposed between the dielectric base member 41 and the main plate 21. A situation in which the dielectric base member 41 hits the main plate 21 and is broken can therefore be avoided.

### Distance Between Antenna Electrode Section and Metal Members

In the principle based on which a patch antenna operates, since a strong electric field along the edge of the patch (antenna electrode section 42) is radiated from the edge toward the surrounding space (when patch antenna is used as transmission antenna), lines of strong electric force are present in the vicinity of the antenna and are readily affected by a nearby metal and dielectric object. In particular, metal members located above the antenna electrode section 42 (on the side facing the cover glass plate 31) greatly affect the lines of electric force.

In view of the circumstances described above, the positional relationship between the metal members disposed above the upper surface of the planar antenna 40 (antenna electrode section 42) and the antenna electrode section 42 is set as follows.

In the present embodiment, the metal members located above the upper surface of the planar antenna 40 are the case body 11 (barrel 111) of the exterior case 10, the first antimagnetic plate 91, the electrode section of the solar cell panel 25.

Now, let D1 be the minimum distance between the antenna electrode section 42 and the case body 11, D2 be the minimum distance between the antenna electrode section 42 and the first antimagnetic plate 91 disposed on the rear surface of the dial 2, and D3 be the minimum distance between the antenna electrode section 42 and the electrode portion of the solar cell panel 25, as shown in FIG. 4. Further, let t be the thickness of the planar antenna 40.

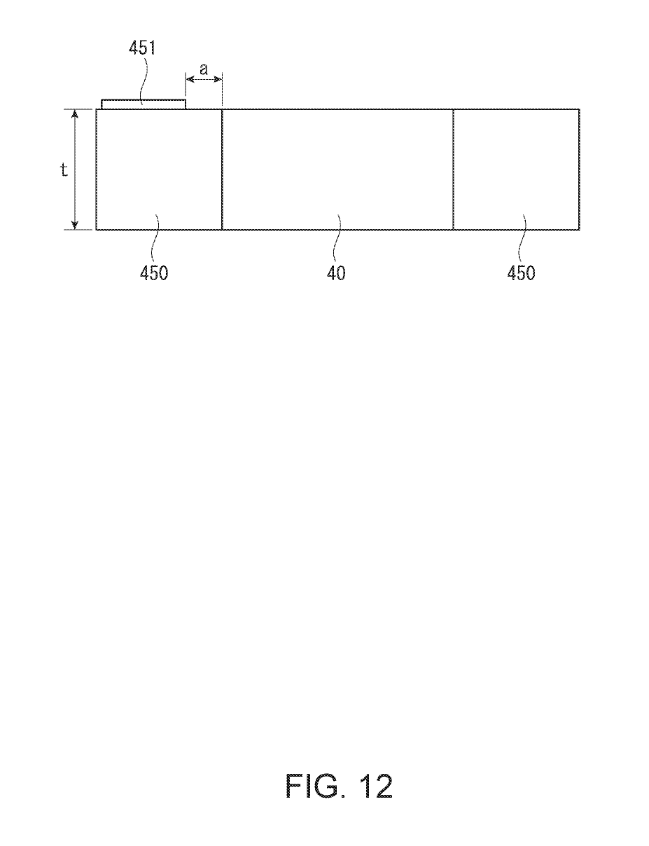

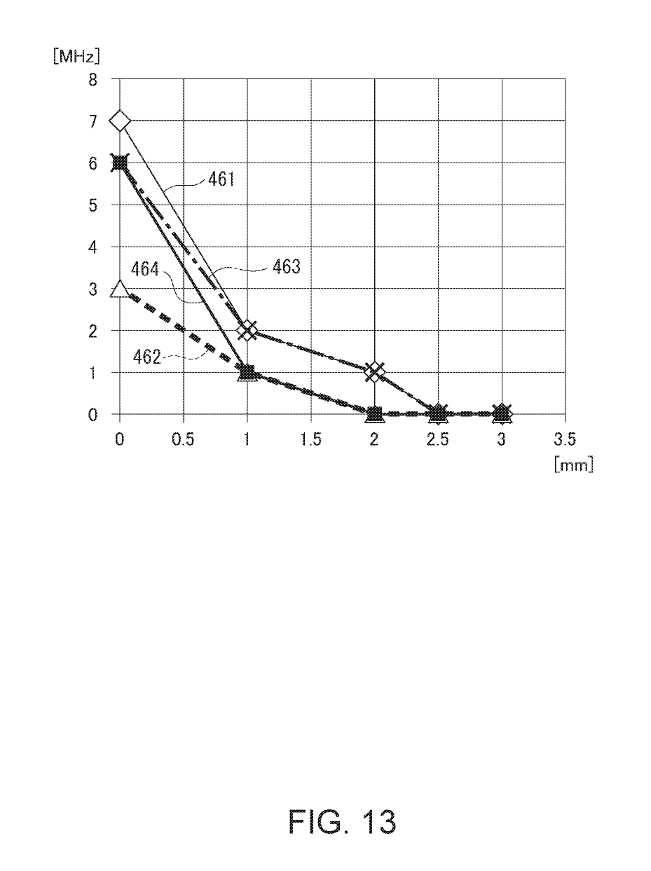

To set D1 to D3 described above, an experiment example for examining the influence of the distances between the antenna electrode section 42 and the metal members on the reception characteristic will be described with reference to FIGS. 12 and 13.

The planar antenna 40 used in the experiment example was a planar antenna having an 11×11-mm rectangular shape in the plan view and having a thickness t of 3 mm. A Styrofoam block 450 was disposed around the planar antenna 40, and a metal piece 451, formed of an electrode of a solar cell, was disposed on the upper surface of the Styrofoam block 450, as shown in FIG. 12. The distance “a” between the planar antenna 40 and the metal piece 451 was then changed to examine the influence of the distance “a” on the planar antenna 40. The degree of the influence on the planar antenna 40 was evaluated by a change in the resonance frequency of the antenna.

FIG. 13 shows results of the experiment. In the experiment, the distances “a” from each of the four side surfaces 413A to 413D to the metal piece 451 was changed.

In FIG. 13, the horizontal axis represents the distance “a” (mm), and the vertical axis represents the amount of frequency shift (MHz). The line 461 represents the amount of frequency shift in the case where the distance from the metal piece 451 to the side surface 413A is changed. The other lines 462 to 464 represent the amounts of frequency shift in the cases where the distances from the metal piece 451 to the second side surface 413B to the fourth side surface 413D are changed.

The amount of frequency shift was 0 MHz when the metal piece 451 is separate from any of the side surfaces 413A to 413D by at least 2.5 mm, as shown in FIG. 13. That is, the influence of the metal member can be reduced by setting the dimension “a” to be at least about 80% the thickness of the planar antenna 40 (3 mm).

In the present embodiment, the minimum distances D1 to D3 are therefore each set at 2.4 mm, which is 80% the thickness of the planar antenna 40 (t=3 mm), or greater.

### Circuit Configuration of Electronic Timepiece

FIG. 14 is a schematic view showing the circuit configuration of the electronic timepiece 1.

The electronic timepiece 1 includes the planar antenna 40, a filter (SAW) 35, the receiver 50, a control display section 60, and a power supply section 70.

The filter 35 is a bandpass filter and transmits a 1.5-GHz satellite signal. An LNA (low noise amplifier) that increases the reception sensitivity may be separately incorporated between the planar antenna 40 and the filter 35. The filter 35 may instead be incorporated in the receiver 50.

The receiver 50 processes the satellite signal having passed through the filter 35 and includes an RF (ratio frequency) section 51 and a baseband section 52.

The RF section 51 includes a PLL circuit 511, a VCO (voltage controlled oscillator) 512, an LNA (low noise amplifier) 513, a mixer 514, an IF amplifier 515, an IF filter 516, an ADC (A/D converter) 517, and other components.

The satellite signal having passed through the filter 35 is amplified by the LNA 513 and then so mixed by the mixer 514 with a signal from the VCO 512 as to be down-converted into an IF (intermediate frequency) signal.

The IF signal produced by the mixing in the mixer 514 passes through the IF amplifier 515 and the IF filter 516 and is converted by the ADC (A/D converter) 517 into a digital signal.

The baseband section 52 includes a DSP (digital signal processor) 521, a CPU (central processing unit) 522, an RTC (real-time clock) 523, and an SRAM (static random access memory) 524. A temperature compensated crystal oscillator circuit (TCXO) 53, a flash memory 54, and other components are also connected to the baseband section 52.

Thus configured baseband section 52, to which the digital signal is inputted from the ADC 517 in the RF section 51, performs correlation, positioning computation, and other types of operation to be capable of acquisition of satellite time information and positioning information.

The clock signal for the PLL circuit 511 is generated by the temperature compensated crystal oscillator circuit (TCXO) 53.

The control display section 60 includes a controller (CPU) 61, the drive circuit 62, which drives the second hand 3B, the minute hand 3C, the hour hand 3D, and other components, a time display section, and an information display section.

The controller 61 is formed of an RTC 611 and a storage 612.

The RTC 611 uses a reference signal outputted from the crystal oscillator 63 to measure the internal time information.

The storage 612 stores the satellite time information and the positioning information outputted from the receiver 50. The storage 612 further stores time difference data corresponding to the positioning information, allowing calculation of local time at the current location based on the internal time information measured by the RTC 611 and the time difference data.

The electronic timepiece 1 according to the present embodiment, which includes the receiver 50 and the control display section 60 described above, can automatically correct the time display based on the satellite signals received from the GPS satellites S.

The power supply section 70 is formed of the solar cell panel 25, a charge control circuit 71, the secondary battery 24, a first regulator 72, a second regulator 73, and a voltage detection circuit 74.

The solar cell panel 25, when it receives light and generates electric power, supplies the secondary battery 24 via the charge control circuit 71 with the electric power generated in the photoelectric power generation to charge the secondary battery 24.

The secondary battery 24 supplies the control display section 60 with drive electric power via the first regulator 72 and supplies the receiver 50 with drive electric power via the second regulator 73.

The voltage detection circuit 74 monitors the voltage across the secondary battery 24 and outputs the voltage to the controller 61. The controller 61 can therefore control the reception while grasping the voltage across the secondary battery 24. Further, the voltage detection circuit 74 detects the open voltage of the solar cell panel 25 with the solar cell panel 25 disconnected from the secondary battery 24 and outputs the open voltage to the controller 61 by the charge control circuit 71. The controller 61 can therefore evaluate whether or not the electronic timepiece 1 is located outdoors by grasping the intensity of light with which the solar cell panel 25 is irradiated. The solar cell panel 25 therefore also functions as an outdoor detection sensor. The outdoor detection sensor is not limited to the solar cell panel 25 not only for power generation but for outdoor detection and may be formed of a dedicated sensor, such as an ultraviolet sensor and an illuminance sensor.

The charge control circuit 71 and the voltage detection circuit 74 are formed as part of the power supply IC 75. The memory IC 76 and the chip device 761 are not shown in FIG. 14.

### Automatic Reception

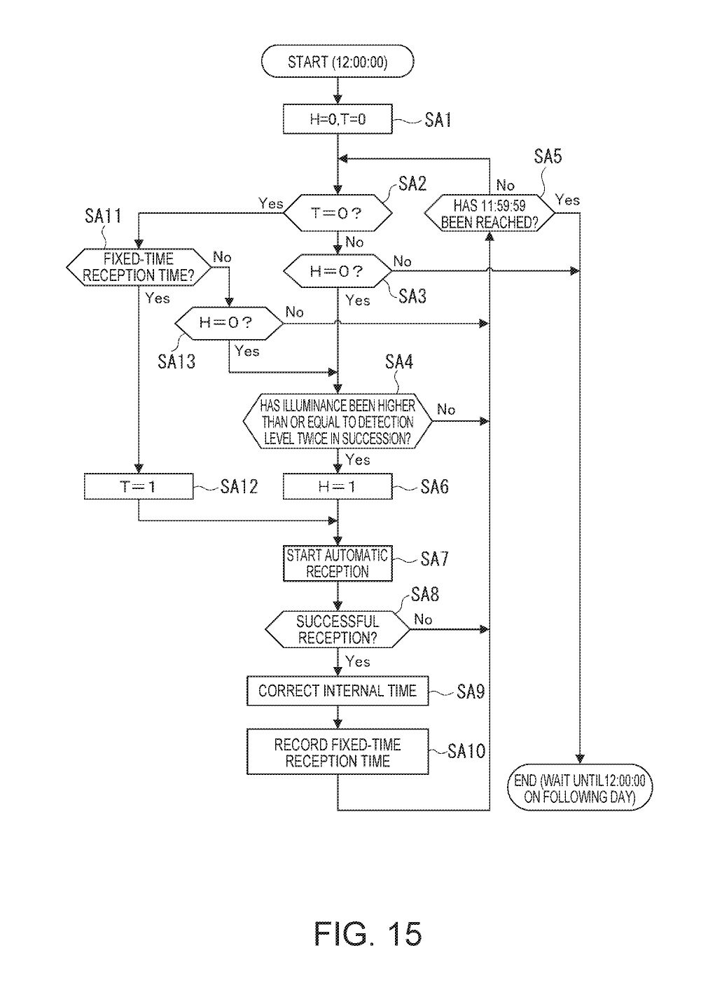

FIG. 15 is a flowchart showing satellite signal automatic reception performed by the controller 61. The automatic reception includes fixed-time reception in which the reception starts at preset time and outdoor reception in which the reception starts when it is detected that the electronic timepiece 1 is located outdoors. The automatic reception is the process of capturing at least one of the position information satellites S to receive a satellite signal and acquiring time information to correct the internal time.

The controller 61 starts the reception at reception control start time stored in the storage 612. In the present embodiment, the reception control start time is set at 12:00:00 (24-hour system) every month. The controller 61 therefore starts the reception control in FIG. 15 when the internal time measured by the RTC 611 reaches 12:00:00.

The controller 61, when it starts the reception control, first initializes variables H and T to “0” (SA1).

The variable H is a variable showing whether or not the controller 61 has performed outdoor reception within a time range specified in advance, in the present embodiment, 24 hours from 12 o'clock that is the control start time to 11:59:59 on the following day immediately before the following control start time. The initial value of the variable H is “0”, and the variable H is maintained at “0” when no outdoor reception has been performed and is updated to “1” when the output reception has been performed.

The variable T is a variable showing whether or not the controller 61 has performed the fixed-time reception within the same time range (24 hours from 12 o'clock). The initial value of the variable T is “0”, and the variable T is maintained at “0” when no fixed-time reception has been performed and is updated to “1” when the fixed-time reception has been performed.

For example, in a case where the fixed-time reception time is 15 o'clock, the variable T is “0” from 12 o'clock to 15 o'clock, and when the fixed-time reception is performed at 15 o'clock, the variable T becomes “1”. The variable T is then maintained at “1” from 15 o'clock to 24 o'clock and further to 12 o'clock on the following day and initialized to “0” at 12 o'clock on the following day.

The control start time, that is, the timing when the variables H and T are initialized is not limited to 12:00:00 (noon) and may instead be set at 0:00:00 (midnight) in accordance with the timing when the date changes, may be set at 5:00:00 AM in consideration of the timing when people wake up and start activity, or maybe set at any other point of time. That is, the control start time may be set as appropriate depending on how the user desires to perform the fixed-time reception. The control start time may be specified by the user himself/herself.

Still instead, the control start time may be set at two or more points of time every day or may be set at one point of time over a period longer than or equal to two days. That is, the length of the temporal range from control start time to the following control start time is not limited to 24 hours and may be any length of time. It is, however, usually preferable that the length of the temporal range is set at a period longer than or equal to half a day, such as half a day (12 hours), one day (24 hours), and two days (48 hours).

Further, the variables H and T described above are each set at “1” when the reception is performed irrespective of the result of the reception, that is, successful or unsuccessful reception. That is, even when the reception is unsuccessful, the variables H and T are each set at “1”.

### Outdoor Reception

When the variable H is “0”, that is, when no outdoor reception has been performed, the controller 61 activates the receiver 50 to perform the outdoor reception.

Specifically, after the initialization of the variables, the controller 61 evaluates whether or not the variable T is “0” (SA2). In a case where the variable T is “1” (No in SA2) and the variable H is “0” (Yes in SA3) or in a case where the variable T is “0” (Yes in SA2), the fixed-time reception time has not been reached (No in SA11), and the variable H is “0” (Yes in SA3), the controller 61 activates the receiver 50 to perform the outdoor reception.

### Outdoor Evaluation

The controller 61 evaluates whether or not the illumination detection level of the open voltage corresponding to the illuminance of light incident on the solar cell panel 25 has been greater than or equal to a set threshold (detection level) twice in succession, for example, at 1-second intervals (SA4).

In a case where the evaluation in SA4 shows No (in low-illuminance state), the controller 61 determines that the electronic timepiece 1 is unlikely to be located outdoors or present at a location suitable for reception of the GPS signals. The controller 61 then evaluates whether or not the current time has reached 11:59:59 (SA5).

In a case where the evaluation in SA5 shows No, the controller 61 returns to SA2 and continues the outdoor evaluation. On the other hand, in a case where the evaluation in SA5 shows Yes, the controller 61 terminates the reception control and transitions to a standby state in which the controller 61 waits until the control resumption time when the controller 61 starts the reception control next time. The control resumption time is 12:00:00 one second after the evaluation in SA5.

In a case where the evaluation in SA4 shows Yes, it can be expected that a state suitable for reception of the GPS satellite signals has been achieved, the controller 61 starts the automatic reception. The controller 61 first sets the variable H at “1” (SA6). The controller 61 then activates the receiver 50 to start reception of the GPS satellite signals (SA7).

The reception initiated in SA7 is performed also in the fixed-time reception, which will be described later, as well as in the outdoor reception performed in the case where the evaluation in SA4 shows Yes. The outdoor reception (light-response automatic reception) and the fixed-time reception are hereinafter collectively referred to as the “automatic reception” in some cases.

The automatic reception in SA7 is so set that reception in the time measuring mode is performed.

After the automatic reception is initiated in SA7, the controller 61 evaluates whether or not the GPS satellite signals have been successfully received (SA8). In a case where the evaluation shows successful reception (Yes in SA8), the internal time measured by the RTC 611 is corrected based on the time information acquired from the received satellite signals (SA9).

The controller 61 records the time when the current successful automatic reception started (automatic reception successful time) as the fixed-time reception time in the storage 612 (SA10).

The controller 61 performs the control end time evaluation in SA5 both in a case where the evaluation in SA8 shows No and in the case where the internal time is corrected in SA9, the fixed-time reception time is recorded in SA10, and other types of operation are performed, as in the case where the evaluation in SA4 shows No.

### Fixed-Time Reception

On the other hand, in the case where the evaluation in SA2 shows Yes (variable T is “0”), the controller 61 evaluates whether or not the fixed-time reception time has been reached (SA11).

The fixed-time reception time is reception start time when the preceding successful reception started and is stored in the storage 612, as described above. The controller 61 therefore evaluates whether or not the internal time has reached the fixed-time reception time. The controller 61, when it determines that the internal time has reached the fixed-time reception time (Yes in SA11), sets the variable T described above at “1” (SA12). The controller 61 then activates the receiver 50 to start the automatic reception (SA7).

The controller 61 then evaluates whether or not the reception has been successful (SA8), and in the case where the reception was successful, the controller 61 performs the internal time correction (SA9) and the fixed-time reception time recording (SA10), as in the outdoor reception. In a case where the reception is successful in the fixed-time reception, the automatic reception start time is equal to the fixed-time reception time stored in the storage 612. In SA10, the same time is therefore set as the fixed-time reception time. The fixed-time reception time recording in SA10 may therefore be performed only in the case of successful outdoor reception.

On the other hand, in the case where the evaluation in SA11 is No, the controller 61 evaluates whether or not the variable H is “0” (SA13). In the case where the evaluation in SA13 shows Yes, that is, in the case where T=0 or no fixed-time reception has been performed and H=0 or no outdoor reception has been performed, the controller 61 performs the outdoor reception (SA4 to SA10).

On the other hand, in a case where the evaluation in SA3 shows No, that is, in a case where H=1 or the outdoor reception has been performed but T=0 or not fixed-time reception has been performed, the controller 61 returns to the evaluation in SA5.

In the case where the evaluation in SA3 is No, that is, T=1 or the fixed-time reception has been performed and H=1 or the outdoor reception has also been performed, the outdoor reception and the fixed-time reception have each been performed once, and the controller 61 therefore terminates the reception control and transitions to the standby state until 12:00:00 on the following day, which is the control resumption time.

That is, the reception control is terminated under the condition that the controller 61 performs each of the outdoor reception and the fixed-time reception once irrespective of successful or unsuccessful reception.

Further, the fixed-time reception is unfailingly performed in the period from control start time to the following control start time, but the outdoor reception cannot be performed unless the evaluation in SA4 shows Yes. In a case where whether the electronic timepiece 1 is located outdoors cannot be detected in SA4, the processes in SA2 to SA5 are repeated until the evaluation in SA5 shows Yes.

### Advantageous Effects of Embodiment

In the electronic timepiece 1, since the power feeder 44 of the planar antenna 40 is disposed in a 3-o'clock or 9-o'clock position, the in-plane (XY-plane) directivity of the planar antenna 40 coincides with the 3-to-9-o'clock direction in the reception of a right-handed polarized wave signal, such as a GPS satellite signal. Therefore, when the user walks with the electronic timepiece 1 worn around a wrist, the 3-to-9-o'clock direction of the electronic timepiece 1 can be oriented toward the zenith and therefore receive the satellite signals transmitted from the position information satellites S with satisfactory sensitivity.

Therefore, since the probability of successful automatic reception can be particularly improved, and the internal time can be automatically corrected, the accuracy of the displayed time can also be improved, whereby a highly convenient electronic timepiece 1 can be provided.

In the planar antenna 40, since the power feeder 44 is disposed in a 9-o'clock position, the 9-o'clock direction of the electronic timepiece 1 can be oriented toward the zenith when the arms extend downward in the vertical direction. Therefore, even when the arms are swung forward and rearward during walking, a change in the reception sensitivity can be reduced, whereby the probability of successful automatic reception can be further improved.

Since the planar antenna 40 is disposed in a 12-o'clock position with respect to the center of the dial 2, and the power feeder 44 is disposed in a 9-o'clock position with respect to the center of the planar antenna 40, the power feeder 44 can be disposed so as to be separate from the exterior case 10.

The influence of the case body 11 made of a metal on the planar antenna 40 can therefore be reduced, whereby the reception sensitivity of the planar antenna 40 can be improved.

In the planar antenna 40, since the power feeder 44 is formed of the feeding electrode 441 and the side surface electrode 442 into a strip electrode, the thickness of the planar antenna 40 can be reduced as compared with a case where a power feeder using a power feeder pin is employed, whereby the planar antenna 40 can be readily manufactured in a surface mounting process. Further, providing a power feeder pin in the vicinity of the edge of the planar antenna 40 (in a position shifted from the center of the antenna) results in some cases in breakage of the dielectric substrate 41 made of a ceramic material, but the breakage of the dielectric substrate 41 can be avoided because no power feeder pin is used in the present embodiment.

Since the planar antenna 40 is disposed in one of the two regions divided by the second straight line 102, and the secondary battery 24 is disposed in the other region, the planar antenna 40 and the secondary battery 24 can be disposed so as to be separate from each other. The influence of the secondary battery 24 can therefore be suppressed, whereby the reception sensitivity of the planar antenna 40 can be improved.

Since the minimum distance D1 from the antenna electrode section 42 to the case body 11 made of a metal, the minimum distance D2 from the antenna electrode section 42 to the first antimagnetic plate 91, and the minimum distance D3 from the antenna electrode section 42 to the electrode section of the solar cell panel 25 are each set to be at least 80% the thickness t of the planar antenna 40, no frequency shift occurs, as indicated by the experimental data shown in FIG. 13, whereby the influence of the metal members on the reception sensitivity of the planar antenna 40 can be reduced.

Since the interior of the exterior case 10 is imaginarily divided into the four regions 105 to 108, and none of the second antimagnetic plate 92, the stepper motors 221 to 225, and the crystal oscillator 63 is disposed in the region 108, where the receiver 50 is disposed, the influence of the metal members on the power feed line 46 can also be reduced, whereby degradation in the sensitivity of the planar antenna 40 can be suppressed.

Further, since the power feed line 46 is obliquely extracted from the power feeder 44 and linearly wired to the receiver 50, a change in the characteristic impedance of the power feed line 46 can be suppressed, whereby the influence of noise on the power feed line 46 can be minimized.

Since the planar antenna 40 can be disposed so as not to overlap with the stepper motors 221 to 225 or the secondary battery 24 in the plan view, the dielectric substrate 41 can have a layered configuration. Therefore, even when the planar antenna 40 is configured so as to have a small planar size as to be incorporated in the electronic timepiece 1 having a wristwatch size, the reception sensitivity of the planar antenna 40 can be ensured. The planar antenna 40 overlaps with the dial 2 in the plan view, but the dial 2 is formed of a non-electrically-conductive member, whereby the reception performance of the planar antenna 40 can be ensured. Further, even when the indicating hands 3 are each formed of an electrically conductive member, the indicating hands 3 each have a needle-like shape and therefore have a small planar area, whereby the influence of the indicating hands 3 on the reception performance can be minimized.

Therefore, an electronic timepiece 1 having ensured reception performance and having a small thickness suitable for a wristwatch can be provided.

Since the winding stem, the setting lever, and other switching mechanisms are disposed in 3-o'clock positions on the dial 2 in the plan view, disposing the planar antenna 40 and the secondary battery 24, which are each a relatively large part among the timepiece parts, also in 3-o'clock positions requires an increase in the planar size of the electronic timepiece 1. In contrast, in the present embodiment, the planar antenna 40 and the secondary battery 24 are disposed in positions away from 3-o'clock positions and do not therefore interfere with the switching mechanisms disposed in 3-o'clock positions in the timepiece part arrangement, whereby the planar size of the electronic timepiece 1 can be reduced.

Since the secondary battery 24 is disposed in the cutout 731 of the second circuit substrate 724, the thickness of the electronic timepiece 1 can be reduced as compared with a case where the battery is disposed on the side facing the rear surface of the second circuit substrate 724, whereby the thickness of the electronic timepiece 1 can be reduced.

Since part of the exterior case 10, for example, the barrel 111, the bezel 112, and the case back 12 can each be made of a metal, the texture of the electronic timepiece 1 can be improved. Further, since the dial ring 32 and other ring members disposed along the outer circumference of the dial 2 are each formed of a non-electrically-conductive member, the planar antenna 40 can receive the satellite signals from the side facing the cover glass plate 31 of the timepiece through the dial 2, the dial ring 32, and the main plate 21, whereby the reception performance can be ensured even with the metal barrel 111, bezel 112, and case back 12.

Since the planar antenna 40 is disposed in a 12-o'clock position with respect to the center of the dial 2, the planar antenna 40 interferes with none of the indicating hand shafts 4B, 4C, and 4D for the indicating hands 771, 781, and 791 in the first small window 770, the second small window 780, and the third small window 790. The exterior appearance of the dial 2 of the electronic timepiece 1 can therefore be designed with little restriction.

Since the cushion material 47 is disposed between the main plate 21 and the front surface 411 of the dielectric substrate 41, and the front surface 411 of the planar antenna 40 is caused to be in contact with the cushion material 47, the position of the planar antenna 40 in the thickness direction (height direction) of the electronic timepiece 1 can be set with precision. The positional precision of the planar antenna 40 with respect to the main plate 21 can therefore be improved, whereby the amount of change in the antenna frequency due to variation in the positional precision can be further reduced for more stable antenna characteristic.

Further, since the front surface 411 of the planar antenna 40 is in contact with the cushion material 47, direct contact of the front surface 411 with the main plate 21 can be avoided, whereby breakage of the dielectric substrate 41 made of a ceramic material can be avoided.

Since the date indicator 5 is formed of a non-electrically-conductive member, the arrangement in which the date indicator 5 overlaps with the planar antenna 40 in the plan view still allows the satellite signals to pass through the date indicator 5 and impinge on the antenna, whereby a decrease in the reception performance can be avoided.

Since the date indicator 5 overlaps with the planar antenna 40 in the plan view, the indicating hand shafts 3A, 4B, 4C, and 4D for the indicating hands 3, 771, 781, and 791, which are disposed so as to be separate from the date indicator 5 and the planar antenna 40, can be disposed with increased flexibility, whereby the electronic timepiece 1 can be designed with improved flexibility.

Since the planar antenna 40 does not overlap with the solar cell panel 25 or the antimagnetic plate 91 or 92 in the plan view, the satellite signals propagating through the front surface of the timepiece are incident on the planar antenna 40 without being blocked by the solar cell panel 25 or the antimagnetic plate 91. The solar cell panel 25 and the antimagnetic plates 91 and 92 can therefore be provided in the electronic timepiece 1 with no decrease in the reception performance.

The barrel 111 and the case back 12, which are connected to the ground portion of the receiver 50, function as the ground plane. The area of the ground plane can therefore be increased, and the antenna gain is improved accordingly, whereby the antenna characteristics can be improved.

### Second Embodiment

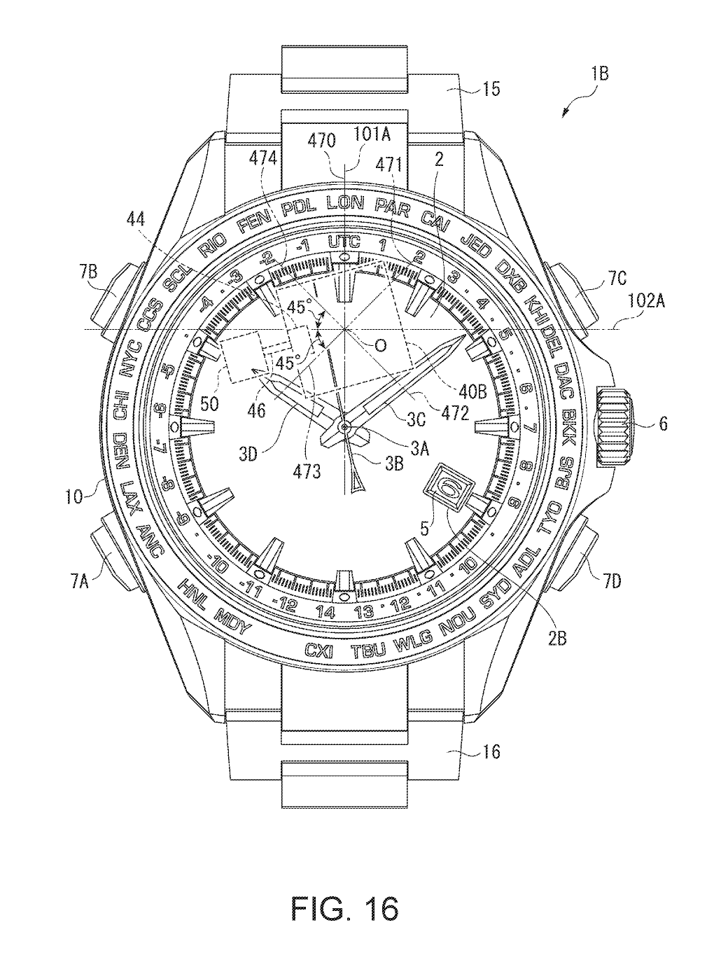

A second embodiment of the invention will next be described with reference to FIG. 16. In the second embodiment, the same or similar configurations as those in the first embodiment have the same reference characters and will not be described.

An electronic timepiece 1B according to the second embodiment differs from the electronic timepiece 1 according to the first embodiment in that a planar antenna 40B is disposed in an inclining attitude. That is, in the electronic timepiece 1 according to the first embodiment, each of the side surfaces 413A to 413D of the planar antenna 40 is disposed so as to be parallel to the first straight line 101, which extends along the 3-to-9-o'clock direction of the electronic timepiece 1, or the second straight line 102, which extends along the 12-to-6-o'clock direction of the electronic timepiece 1.

On the other hand, in the electronic timepiece 1B according to the second embodiment, the side surfaces 413A to 413D of the planar antenna 40B are disposed so as not to be parallel to the first straight line 101 or the second straight line 102 but as to incline with respect thereto.

Also in the planar antenna 40B, the power feeder 44 is disposed in the first or second angular range. That is, when a first straight line 101A, which passes through the center O of the planar antenna 40B and is parallel to the first straight line 101, and a second straight line 102A, which passes through the center O of the planar antenna 40B and is parallel to the second straight line 102, are set, the 1.5-o'clock-direction imaginary line 471 and the 4.5-o'clock-direction imaginary line 472, which define the first angular range, are so set as to incline by 45 degrees with respect to the first straight line 101A and the second straight line 102A, as shown in FIG. 16. Further, the 7.5-o'clock-direction imaginary line 473 and the 10.5-o'clock-direction imaginary line 474, which define the second angular range, are so set as to incline by 45 degrees with respect to the first straight line 101A and the second straight line 102A.

The power feeder 44 of the planar antenna 40B is provided within the second angular range, that is, between the imaginary line 473 and the imaginary line 474, as shown in FIG. 16.

Also in the second embodiment, define the reference line 470, which is parallel to the longitudinal direction of the first band 15 and the second band 16 and extends from the center (origin) O of the planar antenna 40B in the plan view toward the first band 15. As in the first embodiment, the first angular range is the range from 45 to 135 degrees measured clockwise from the reference line 470, that is, the range between the imaginary line 471 to the imaginary line 472. The second angular range is the range from 45 to 135 degrees measured counterclockwise from the reference line 470, that is, the range between the imaginary line 474 to the imaginary line 473. In the second embodiment, the power feeder 44 is disposed in the range from 45 to 135 degrees measured counterclockwise from the reference line 470.

When the planar antenna 40B itself is disposed in an inclining attitude, as in the second embodiment, the power feed line 46, which is connected to the receiver 50, which is the reception IC, can be extracted in the direction perpendicular to the first side surface 413A, whereby the power feed line 46 can be further shortened for reduction in the influence of noise thereon. Further, since the planar antenna 40B can be disposed in an inclining attitude, the flexibility of the timepiece part arrangement increases, whereby the electronic timepiece 1B can be readily designed.

### Other Embodiments

The invention is not limited to the embodiments described above, and a variety of variations are conceivable to the extent that they fall within the scope of the substance of the invention.

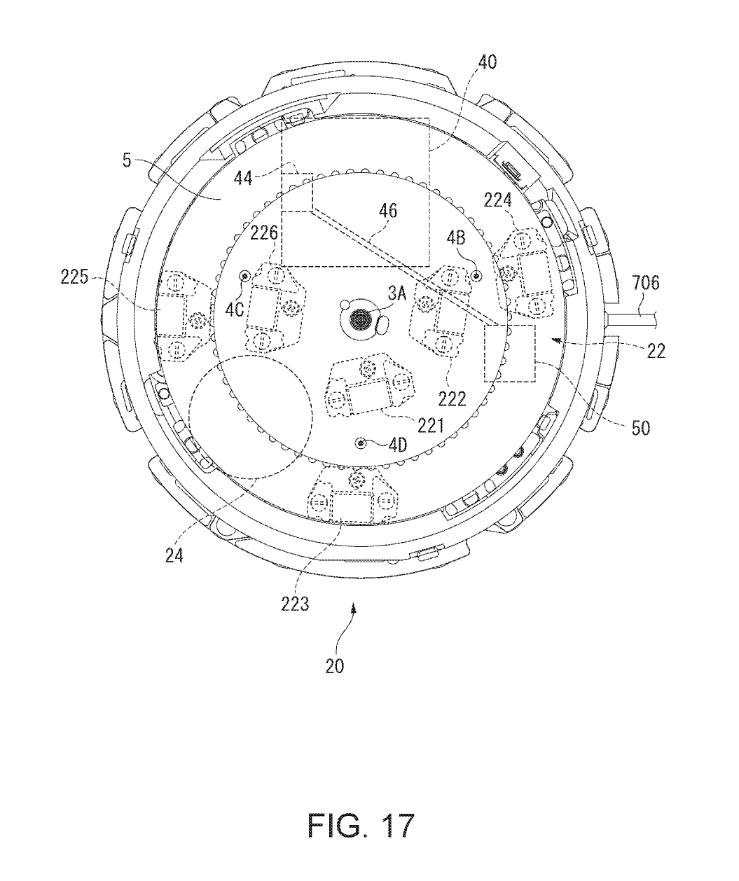

The power feed line 46, which connects the power feeder 44 of the planar antenna 40 to the receiver 50, may be disposed, for example, on the side facing the rear surface of the second circuit substrate 724 so that the power feed line 46 passes below the planar antenna 40, as shown in FIG. 17. In this case, the receiver 50 can be disposed in a position separate from the power feeder 44, whereby the receiver 50 can be arranged with increased flexibility. It is noted that a stepper motor 226, which drives the hour hand 3D, is added to the movement 20 in FIG. 17, and that the second stepper motor 222 drives only the minute hand 3C.

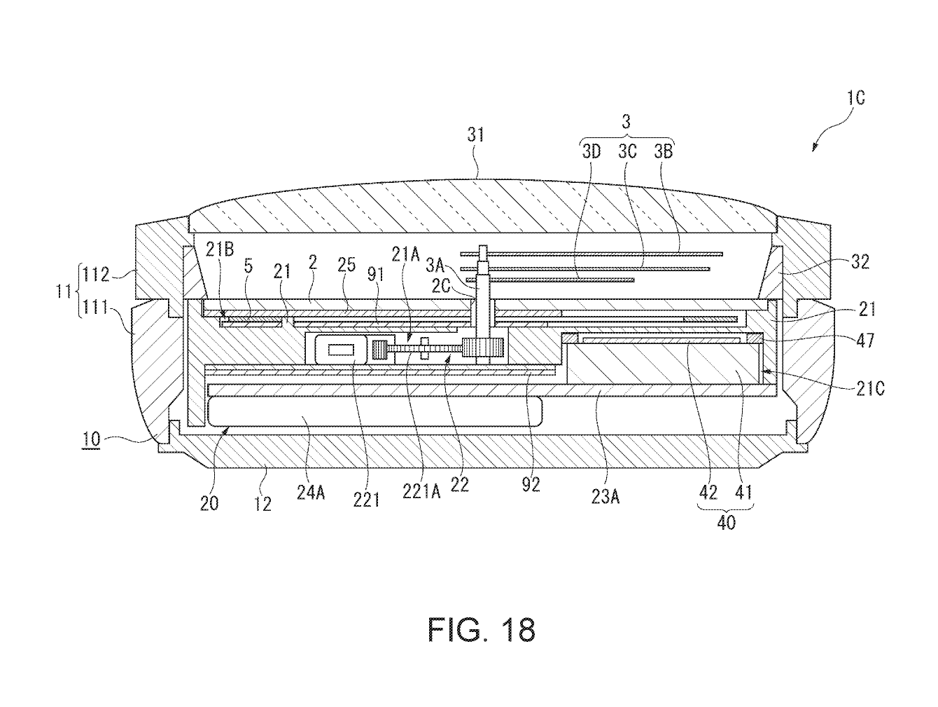

A secondary battery 24A may be disposed on the case-back-side surface of a circuit substrate 23A, on which the planar antenna 40 is mounted, as in an electronic timepiece 1C shown in FIG. 18. In this case, since the secondary battery 24A is located in a position shifted from the planar antenna 40 toward the case back 12, the influence of the secondary battery 24A on the reception can be almost completely eliminated. Further, since there are few parts disposed on the case-back side of the circuit substrate 23A, a large-diameter, thin, coin-shaped battery can be used as the secondary battery 24A.

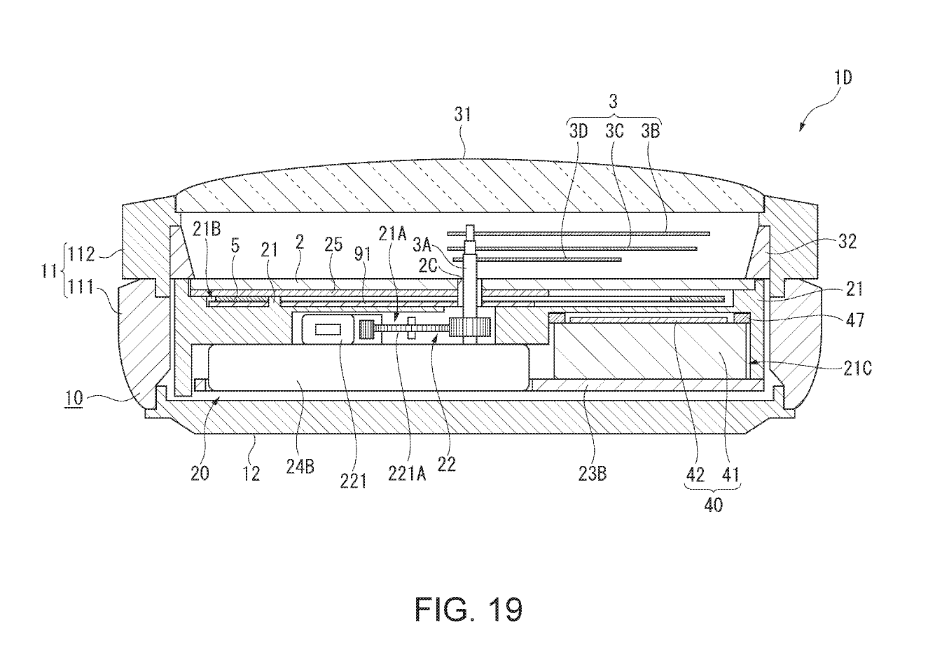

Further, a circuit substrate 23B, on which the planar antenna 40 is mounted, may be provided that serves also as the substrate for a secondary battery 24B, and the planar antenna 40 and the secondary battery 24B may be disposed with respect to the height position of the same circuit substrate 23B, as in an electronic timepiece 1D shown in FIG. 19. In this case, the planar antenna 40 and the secondary battery 24B do not need to be shifted from each other in the height direction, but the secondary battery 24B can be disposed within the height dimension of the planar antenna 40, whereby the thickness of the electronic timepiece 1D can be reduced as compared with the thickness of the electronic timepiece 1C in FIG. 18.

The position where the planar antenna 40 is disposed in the exterior case 10 is not limited to a 12-o'clock position with respect to the center of the dial 2 and may instead be a 6-o'clock position, that is, the position of the center of the planar antenna 40 may fall within the angular range from the 5-o'clock direction to the 7-o'clock direction with respect to the center of the exterior case 10 in the plan view. Still instead, the position where the planar antenna 40 is disposed may be a 3-o'clock position with respect to the center of the dial 2 (position of center of planar antenna 40 may fall within angular range from 2-o'clock direction to 4-o'clock direction) or a 9-o'clock position with respect to the center of the dial (position of center of planar antenna 40 may fall within angular range from 8-o'clock direction to 10-o'clock direction). In the case where the planar antenna 40 is disposed in a 3-o'clock position with respect to the center of the dial 2, the power feeder 44 may be so disposed in the second angular range (in 9-o'clock position) as not to be close to the exterior case 10. Similarly, in the case where the planar antenna 40 is disposed in a 9-o'clock position with respect to the center of the dial 2, the power feeder 44 may be disposed in the first angular range (in 3-o'clock position).

The configurations of the planar antenna 40 and the circuit substrates 723, 724, 23A, and 23B are not limited to those in the embodiments described above. For example, the planar antenna 40 may be so formed that the antenna electrode section 42 layered on the front surface of the dielectric substrate 41 is shifted from the metal members disposed on the timepiece front surface side of the planar antenna 40.

When the antenna electrode section 42 of the planar antenna 40 is disposed so as to be shifted from the metal members (first antimagnetic plate 91 and electrode section of solar cell panel 25), the minimum distances D2 and D3 can be further increased, whereby the amount of electric wave blocked by the metal members can be reduced.

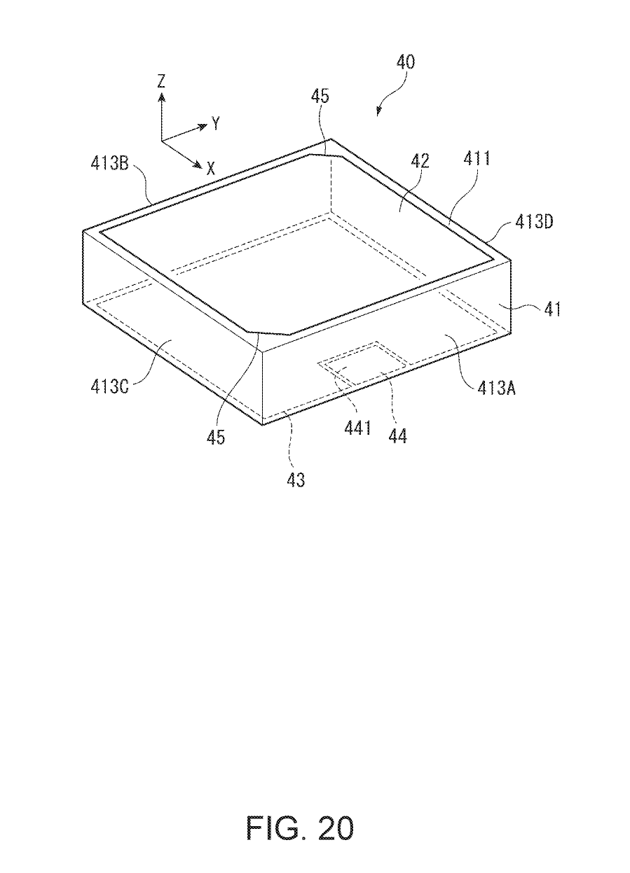

The power feeder 44 of the planar antenna 40 may include only the power feeding electrode 441, as shown in FIG. 20. In this case, the power feeding electrode 441 is capacitively coupled to the antenna electrode section 42 in a central portion of the first side surface 413A. The satellite electric waves received by the antenna electrode section 42 are transmitted to the power feeding electrode 441 via the capacitive coupling and can be extracted from the power feeding electrode 441. The configuration described above can also provide the same effect as that provided by the configuration in which the power feeding electrode 441 and the side surface electrode 442 form the power feeder 44.

In the embodiments described above, the bezel 112 is formed of an electrically conductive member but not necessarily in the invention. For example, the bezel 112 may be made of a ceramic material, such as zirconia (ZrCO₂), which is a non-electrically-conductive material. Zirconia, which not only has high resistivity and therefore does not adversely affect electric wave reception but is hard and excels in scratch resistance, is an excellent material of an exterior member of a timepiece. Further, when the bezel 112 is made of a ceramic material, the bezel 112 is allowed to overlap with the antenna electrode section 42 in the plan view. It is therefore unnecessary to increase the diameter of the barrel 111 so that the bezel 112 does not overlap with the antenna electrode section 42 in the plan view, and the diameter of the barrel 111 can be reduced accordingly, whereby the planar size of the electronic timepiece 1 can be reduced.

In the embodiments described above, the electronic timepiece 1 includes the date indicator 5, the solar cell panel 25, and the dial ring 32, but not necessarily in the invention. That is, the electronic timepiece 1 may not include the date indicator 5, the solar cell panel 25, or the dial ring 32.

In the embodiments described above, the barrel 111 and the case back 12 are connected to the ground portion of the receiver 50 but not necessarily in the invention. That is, the barrel 111 and the case back 12 may not be connected to the ground portion.

In the embodiments described above, the solar cell panel 25 is provided with the cutout 251, which overlaps with the planar antenna 40 in the plan view, but the solar cell panel 25 is not necessarily provided with the cutout 251. The solar cell panel 25 only needs to be configured not to affect the electric wave reception performed by the planar antenna 40 and only needs to be shaped so as not to overlap with the planar antenna 40 in the plan view. For example, the solar cell panel 25 maybe provided with an opening that overlaps with the planar antenna 40 in the plan view, or the solar cell panel 25 may be formed in a semicircular shape and may be disposed so as not to overlap with the planar antenna 40 in the plan view.

In the embodiments described above, the cutouts 912 and 922 are formed by cutting the first antimagnetic plate 91 and the second antimagnetic plate 92, but the first and second antimagnetic plates are not limited to those having cutouts formed therein. That is, in consideration of influence on the reception, the first antimagnetic plate 91 and the second antimagnetic plate 92 may each be shaped so as to be separate from the planar antenna 40 by an appropriate distance.

In the above description, the GPS satellites S are presented as an example of the position information satellites, but not necessarily. For example, the position information satellites can, for example, each be any of the satellites used in GALILEO (EU), GLONASS (Russia), BeiDou (China), and other global navigation satellite systems (GNSS). Further, a stationary satellite such as a satellite used in a satellite-based augmentation system (SBAS) and other stationary satellites, a satellite used in a global satellite positioning system (RNSS) that allows search only in a specific area, such as a quasi-zenith satellite, and any other satellite can be used.

The planar antenna 40 is not limited to the patch antenna described above and may instead be a chip antenna or any other type of planar antenna, and an appropriate planar antenna may be used in accordance with the type of a signal to be received.

The entire disclosures of Japanese Patent application nos. 2017-066173 filed Mar. 29, 2017 and 2017-245503 filed Dec. 21, 2017 are expressly incorporated by reference herein.

What is claimed is:

1. An electronic timepiece comprising:
a case;
a planar antenna disposed in the case and configured to receive a circularly polarized wave; and
a controller configured to activate the planar antenna,
wherein the planar antenna includes:
an antenna electrode having a degeneracy separator; and
a power feeder,
the power feeder is disposed within a first or second angular range with respect to a center of the planar antenna, and
the first angular range is from a 1.5-o'clock direction to a 4.5-o'clock direction of the planar antenna, and
the second angular range is from a 7.5-o'clock direction to a 10.5-o'clock direction of the planar antenna.

2. The electronic timepiece according to claim 1,
wherein the power feeder is disposed at a 3-o'clock or a 9-o'clock position with respect to the center of the planar antenna.

3. The electronic timepiece according to claim 1,
wherein the center of the planar antenna is located within an angular range from an 11-o'clock direction to a 1-o'clock direction or an angular range from a 5-o'clock direction to a 7-o'clock direction with respect to a center of the case in a plan view.

4. The electronic timepiece according to claim 1,
wherein the planar antenna includes:
a dielectric substrate,
the antenna electrode provided on a front surface of the dielectric substrate,
a ground electrode provided on a rear surface of the dielectric substrate, and
a power feeding electrode provided on the rear surface, and
the power feeding electrode is the power feeder.

5. The electronic timepiece according to claim 1,
wherein the planar antenna includes:
a dielectric substrate,
the antenna electrode provided on a front surface of the dielectric substrate,
a ground electrode provided on a rear surface of the dielectric substrate,
a power feeding electrode provided on the rear surface, and
a side surface electrode provided on a side surface of the dielectric substrate and electrically continuous with the power feeding electrode, and
the power feeder is formed of the power feeding electrode and the side surface electrode.

6. The electronic timepiece according to claim 1, further comprising:
a battery disposed in the case,
wherein an interior of the case is divided into two regions by a first straight line passing through the center of the case, the first straight line being perpendicular to a second straight line passing through a center of the case and the center of the planar antenna, and
the battery is disposed in a first of the two regions and the planar antenna is disposed in a second of the two regions.

7. The electronic timepiece according to claim 1, further comprising:
a metal member that is disposed in a position shifted from the planar antenna toward a front surface of the timepiece and that does not overlap with the planar antenna in a plan view,
wherein a minimum distance between the metal member and the antenna electrode is at least 80% of a thickness of the planar antenna.

8. The electronic timepiece according to claim 1, further comprising:
at least one of a crystal oscillator, a motor, and an antimagnetic plate,
wherein an interior of the case is divided into four quadrant regions by a first straight line passing through a center of the case and the center of the planar antenna and a second straight line perpendicular to the first straight line and passing through the center of the case, and
the at least one of the crystal oscillator, the motor, and the antimagnetic plate is disposed in a different quadrant region than the quadrant region where the power feeder is disposed.

9. The electronic timepiece according to claim 1,
wherein the planar antenna is a patch antenna.

10. The electronic timepiece according to claim 1, further comprising:
a circuit substrate on which the planar antenna and a reception IC for the planar antenna are mounted,
wherein an entirety of a wiring line that connects the power feeder of the planar antenna to the reception IC linearly extends along the circuit substrate.

11. An electronic timepiece comprising:
a case;
a dial disposed in the case;
a planar antenna disposed in the case, the planar antenna facing a rear surface of the dial and configured to receive a circularly polarized wave;
a controller configured to activate the planar antenna; and
first and second bands connected to a 12-o'clock side and a 6-o'clock side of the case respectively,
wherein the planar antenna includes:
an antenna electrode having a degeneracy separator; and
a power feeder,
the power feeder is disposed within a first or second angular range with respect to a center of the planar antenna, and
a reference line has an origin at the center of the planar antenna and extends from the origin toward the first band, the first angular range is from 45 to 135 degrees measured from the reference line clockwise around the origin, and the second angular range is a range from 45 to 135 degrees measured from the reference line counterclockwise around the origin.

12. An electronic timepiece comprising:
a case having an interior divided into first and second regions by a first straight line passing through a 9 o'clock position, a center, and a 3 o'clock position of the case, the interior being further divided into four quadrants by a second straight line passing through a 6 o'clock position, the center, and a 12 o'clock position of the case;
a battery disposed in the first region in the case;
a planar antenna disposed in the second region in the case, a center of the planar antenna being located on the second straight line, the planar antenna being configured to receive a circularly polarized wave; and
a controller configured to activate the planar antenna,
wherein the planar antenna includes:
an antenna electrode having a degeneracy separator; and
a power feeder,
the power feeder is disposed within a first or second angular region with respect to the center of the planar antenna, and
with 0 degrees being aligned with the 12 o'clock position of the case, the first angular region is from 45 to 135 degrees with respect to the center of the planar antenna, and
the second angular region is from 225 to 315 degrees with respect to the center of the planar antenna.

13. The electronic timepiece according to claim 12,
wherein the planar antenna includes:
a dielectric substrate,
the antenna electrode provided on a front surface of the dielectric substrate,
a ground electrode provided on a rear surface of the dielectric substrate, and
a power feeding electrode provided on the rear surface, and
the power feeding electrode is the power feeder.

14. The electronic timepiece according to claim 12,
wherein the planar antenna includes:
a dielectric substrate,
the antenna electrode provided on a front surface of the dielectric substrate,
a ground electrode provided on a rear surface of the dielectric substrate,
a power feeding electrode provided on the rear surface, and
a side surface electrode provided on a side surface of the dielectric substrate and electrically continuous with the power feeding electrode, and
the power feeder is formed of the power feeding electrode and the side surface electrode.

15. The electronic timepiece according to claim 12, further comprising:
a metal member that is disposed in a position shifted from the planar antenna toward a front surface of the timepiece and that is laterally spaced apart from the planar antenna in a plan view,
wherein a minimum distance between the metal member and the antenna electrode is at least 80% of a thickness of the planar antenna.

16. The electronic timepiece according to claim 12, further comprising:
at least one of a crystal oscillator, a motor, and an antimagnetic plate, and
the at least one of the crystal oscillator, the motor, and the antimagnetic plate is disposed in a different quadrant than the quadrant where the power feeder is disposed.

17. The electronic timepiece according to claim 12,
wherein the planar antenna is a patch antenna.

18. The electronic timepiece according to claim 12, further comprising:
a circuit substrate on which the planar antenna and a reception IC for the planar antenna are mounted,
wherein an entirety of a wiring line that connects the power feeder of the planar antenna to the reception IC extends linearly along the circuit substrate.
